(19) United States
(12) Patent Application Publication
(10) Pub. No.: US 2011/0166898 A1
(43) Pub. Date: Jul. 7, 2011

(54) Method, System and Apparatus for Dual One-Leg Facilitation

(76) Inventor: Andrew Zarrow, New York, NY (US)

(21) Appl. No.: 12/988,902

(22) PCT Filed: Apr. 20, 2009
(86) PCT No.: PCT/US2009/041158

§ 371 Date: Feb. 7, 2011

Related U.S. Application Data
(60) Provisional application No. 61/046,776, filed on Apr. 21, 2008.

(51) Int. Cl. G06F 17/30; G06Q 10/00

(52) U.S. Cl. 705/5; 707/812; 707/769; 707/E17.005; 707/E17.014

(57) ABSTRACT

The system is configured to aggregate charter travel availability information, as well as process travel search requests from system users. The system may be configured to actively obtain or passively receive charter data objects. The data objects may include information like available charter equipment (e g, aircraft), availability location and/or time information. The system may be configured to process a variety of object formats from a variety of data sources. The system extracts charter flight data indicators and corresponding flight characteristics to create and populate a charter flight data record, which serve as the foundation for charter data management system components. The system implements search functionality identifying charter flight data records with a best match or alternate suggested results. Charter flight records originate from multiple sources that are published/distributed in standardized or non-standardized ways.

### PRIORITY

This application claims priority under 35 U.S.C. §119(e) to U.S. Provisional Application Ser. No. 61/046,776, titled “Method, System and Apparatus for Dual One-Leg Facilitation”, filed on Apr. 21, 2008, Attorney Docket Number 17211-007PV.

### FIELD

The present invention is directed generally to apparatuses, methods, and systems for facilitating charter data aggregation and management and more particularly, to an apparatus, method and system for receiving/obtaining charter data elements, processing the elements and facilitating system user searches of the processed charter data.

### BACKGROUND

Conventionally, charter travel providers, such as charter airline flight operators, have published and distributed their equipment availability and fee information. This type of information may be published and/or distributed in a variety of standardized or non-standardized formats. There is a significant need to provide a method, system and apparatus that aggregates the various types of availability data, processes the data and presents it in a format that is easily managed. Furthermore, there is a need to provide a system user with a convenient, effective interface for working with the processed data.

### SUMMARY

The disclosure details the implementation of apparatuses, methods, and systems associated with a Travel Aggregation System. In an implementation the system is configured to aggregate travel availability information, as well as process travel search requests from system users. The system may be configured as an intermediary that coordinates the processed data from both entities—a series of travel providers distributing travel availability data and system users submitting travel search requests.

The system may be configured to actively obtain or passively receive certain data objects. These data objects may be configured to include availability information for services, such as charter flight availability. The data objects may include information like available equipment (e.g., aircraft), availability location and/or time information. The system may be configured to process either structured/non-structured data objects from system registered charter data sources or non-registered sources.

In a charter flight system configuration, the system extracts charter flight data characteristics from the data objects and uses the data to create and populate a charter flight data record. These data records serve as the underlying foundation for a charter data aggregation management system component. In one embodiment, one aspect of data aggregation management components involves facilitating a search engine to find available charter flights, which may be configured as one-way legs. A roundtrip or a flight with one or more stops in between departure and destination can be expressed as a series of one-way legs.

The system may be configured to implement search engine functionality to identify charter flight data records that provide an initial match or alternate results (alternate available charter flights) that most closely match a requested charter flight criteria. Charter flight records originate from multiple sources that are published/distributed in standardized or non-standardized ways. The system is also populated with source confidence/veracity scores to indicate the confidence in the automated data extraction tool for non-standardized data extraction. The system accepts and stores available flight requests from clients (or participants/community members, if the system is implemented as a service for a community of users) and automatically alerts users (i.e., indirectly through sales representatives or directly to the prospective customer). The system can be easily integrated into existing software applications to initiate search results, add schedules, retrieve contacts and communicate with other facilities of the system through an application programming interface.

In a further embodiment, the system may be configured to store information about unoccupied repositioning flights due to an earlier one-way leg flight matching and flag these unoccupied repositioning flights as a priority fill. In one implementation, the system may first try to match a user request to one of the available unoccupied repositioning flights that have a high priority fill. If no such repositioning flights exist, the system may then access the low priority available charter flights stored in the system database to identify charter flight data records that provide an initial match or alternate results that most closely match a requested charter flight criteria. In another implementation, the system may also first try to match a user search request with other system users' search requests and/or pending search requests stored in the system database before trying to match a user request to one of the available unoccupied repositioning flights. Depending on the implementation, the system may establish and/or adjust discounts to one or both users of a matched dual one-leg flight. The system administrator may also establish/update system commissions to supplement discounts, establish premium subscription services for dynamic system matching, and/or incorporate a finder's fee for the charter provider's as part of matching users' requests with available equipment.

### BRIEF DESCRIPTION OF THE DRAWINGS

The accompanying drawings illustrate various non-limiting, example, inventive aspects in accordance with the present disclosure:

FIG. 1 is a high-level component diagram illustrating aspects of the system components and some of the entities that interact with the system according to an implementation of the system;

FIG. 2 is a high-level flow diagram illustrating aspects of a charter data aggregation and management process according to an implementation of the system;

FIG. 3 is a flow diagram illustrating aspects of charter data aggregation processing in an airline charter flight implementation of the system;

FIG. 4 is an example of a charter data object received by the system;

FIG. 5A-5E illustrate aspects of the charter data object processing process according to an implementation of the system;

FIG. 6A is a flow diagram illustrating aspects of charter data search request management for a charter flight data implementation of the system;

FIG. 6B is a flow diagram illustrating aspects of charter data management and available equipment and position radius assessment for a charter flight data implementation of the system;

FIG. 6C illustrates further aspects of the available equipment and position radius assessment for a charter flight data implementation of the system;

FIG. 7 is an example of a charter data search request received by the system in an airline charter flight implementation of the system;

FIG. 8A-8E illustrate aspects of charter data search request processing according to an implementation of the system;

FIG. 9 is a flow diagram illustrating aspects of search request update processing according to an implementation of the system;

FIG. 10 is a flow diagram illustrating aspects of an implementation of dual one-leg charter facilitation;

FIG. 11 is a flow diagram illustrating additional aspects of the implementation of dual one-leg charter facilitation from FIG. 10;

FIG. 12 is a flow diagram illustrating aspects of another implementation of dual one-leg charter facilitation;

FIG. 13 illustrates aspects of system-driven service request matching in one implementation;

FIG. 14 illustrates aspects of e-mail formatted user service request response in one implementation

FIGS. 15A-15C show aspects of an implementation of user interfaces in one embodiment; and

FIG. 16 illustrates aspects of computer systemization associated with an implementation of the system.

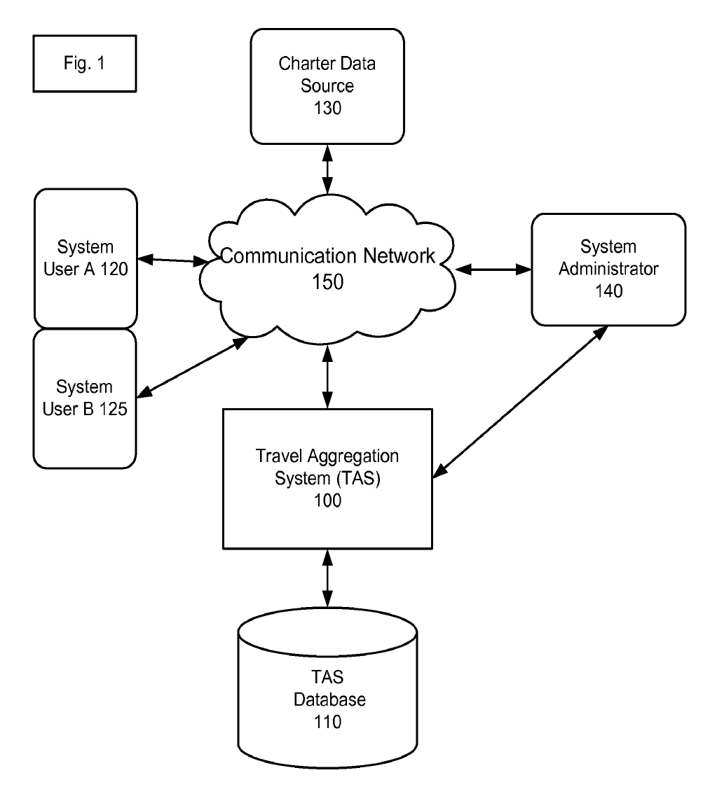

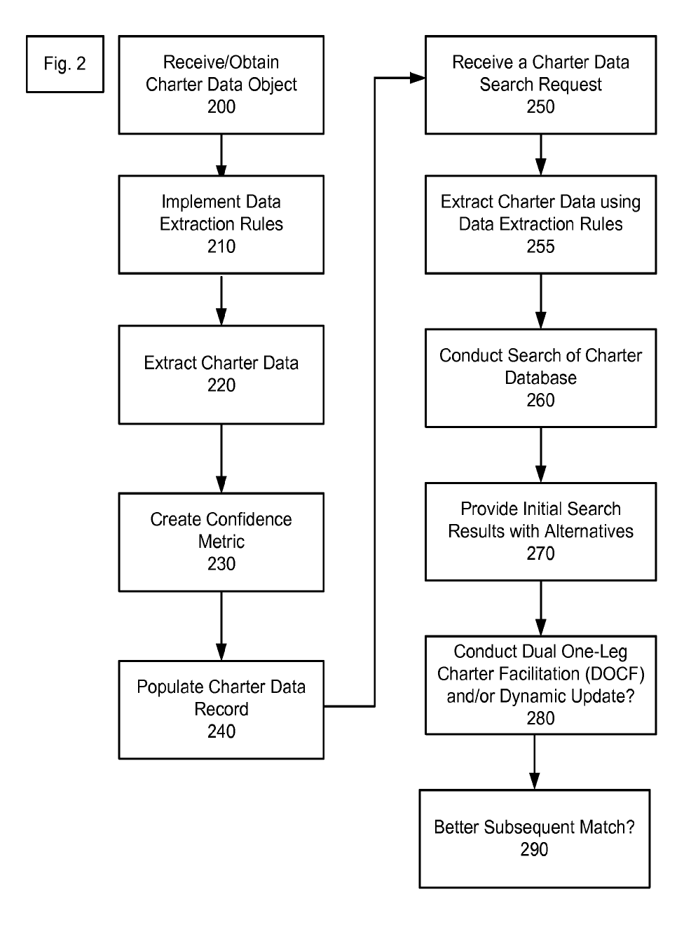

The leading number of each reference number within the drawings indicates the figure in which that reference number is introduced and/or detailed. As such, reference number 101 is first introduced in FIG. 1. Reference number 201 is introduced in FIG. 2, etc.

### DETAILED DESCRIPTION

The system facilitates receiving/obtaining and processing charter data objects that include availability and fee information from a variety of sources, such as travel providers. For the purposes of illustration only in the following figures, the invention will be discussed in an airline context, more specifically as a charter flight data aggregation and processing system. However, it is to be understood that the system, method and apparatus described herein may be adapted to facilitate aggregating and processing any number of different types of data associated with a variety of travel providers and customers. Furthermore, although many aspects of the system are discussed within an airline charter flight context, however, it is to be understood that the system may be configured to meet the needs of a variety of system users beyond a charter flight data implementation discussed herein. For example, the system may be configured to facilitate additional types of travel, freight transportation/shipping, real estate or any number of other implementations that facilitate managing different types of data.

FIG. 1 illustrates a system configuration implemented as a charter data aggregation and processing system or Travel Aggregation System (“TAS”). FIG. 1 illustrates a TAS that includes a primary TAS user interface 100, as well as an underlying TAS database. As will be described in greater detail below, in one embodiment system user A 120 may use the TAS to find available charter flights (“one legs”) for a user-defined search request detailing charter flight criteria. The TAS searches the TAS database for available charter flight records that may originate from a variety of sources 130 depending on the implementation.

The system's travel information database receives data from sources that are non-structured (non-standardized), such as email list-servers or data extracted from scanned advertisements. A system user 120 may navigate the TAS interface individually or with the assistance of a system administrator 140. The system administrator may also work with various charter data sources to coordinate receiving/obtaining charter data objects. Further, the system administrator 140 is also responsible for coordinating the data extraction rules associated with the TAS data object processing modules.

The system 100 accepts and stores available flight requests from system users 120 and 125 and in some embodiments may be configured to automatically alert users about additional flight records that provide a better match than initial matches for particular search requests. The system 100 can be easily integrated into existing software applications to initiate search results, add schedules, retrieve contacts and communicate with other facilities of the system through an application programming interface (API).

As illustrated in FIG. 1, the travel aggregation system (“TAS”) 100 may be configured to receive data from a broad range of resources including, resources that distribute standardized charter (“one-way leg”) availability information to build travel information database. The standardized data sources 130 generate and transmit data from external systems to the TAS in a range of document formats. This might include XML formatted data, remote accessible databases, well-formatted Web sites and/or emails.

Advantageously, the TAS includes an extensive library of charter object formats that facilitate aggregation of the range of document formats. Additional components of the TAS are configured to receive and process requests for available flights originating from potential customers. The requests may be published from charter data sources. Potential customers can also be referred to the travel aggregate system by customer relationship systems, Web sites and other data entry applications.

Additionally, charter data objects (e.g., available flight data and/or requested flight data) might also be supplied in non-structured digital documents (e.g., emails). The TAS 100 is configured to process the text of these documents which are to be semantically/contextually analyzed and an algorithm extracts the charter data records (from available or requested flights). The TAS may be configured to assign a degree of confidence to these records based on its level of understanding of the information. System administrators 140 work with the TAS 100 to develop a system algorithm based on a multitude of extraction rules to process the data records and populate charter flight data records that are used to populate the TAS database 110.

The TAS 100 may be configured with a system data extraction module that parses and extracts charter flights information from non-structured textual digital documents (typically emails) in order to structure the information and populate the TAS database 110. The extraction module is based on a series rules supplied configured to ‘recognize’ certain features/characteristics of travel availability data. The quantity and quality of the information extracted provides the basis for a degree of confidence metric for a particular source. If the extracted data is suspect, the original extraction document can be displayed to the end-user following a search criterion so that no data is mischaracterized/ignored during processing. Alternately, a suspect document may be purged from the system.

The system may be configured to extract a variety of information from charter data objects. For example, the TAS 100 may be configured to process charter data objects configured as a single digital document that might include information about a single or multiple flights with information published by possibly different sources (publisher). Some sources are well known and publish frequently. Other sources publish less frequently and new sources might be added at any time. The objects may include information such as the charter company; the Company, name, address, phone number, web site and email of contact; the plane type, name, model, etc.; the departure date, availability range of dates; the airport base of departure (name of City, airport name, airport code); and/or the destination (city, region, country, airport name or code).

In a further embodiment, the TAS 100 may be configured to receive service requests and/or charter availability data from one or more system users (e.g. System User A 120, System User B 125) and facilitate dual one-leg matching. In one implementation, the TAS 100 may store information in the TAS Database 100 about unoccupied repositioning flights due to earlier one-way leg flight matching, flag these unoccupied repositioning flights as a priority fill and may first try to match a user request to one of these available unoccupied repositioning flights. If no such repositioning flights exist, the TAS 100 may then access the remaining low-priority available charter flights stored in the TAS Database 110 to identify charter flight data records that provide an initial match or alternate results that most closely match a requested charter flight criteria. In another implementation, the TAS 100 may also first try to match a user search request with other system users' search requests and/or pending search requests stored in the TAS Database 110 before trying to match a user request to one of the available unoccupied repositioning flights. Depending on the implementation, the TAS 100 may establish and/or adjust discounts to one or both users of a matched dual one-leg flight. The system administrator 140 may also establish/update system commissions to supplement the discounts, establish premium subscription services for dynamic system matching, and/or incorporate a finder's fee for the charter provider's as part of matching users with available equipment. As illustrated, the various services may be facilitated over communications network 150.

FIG. 2 illustrates a high-level flow diagram illustrating aspects of TAS data aggregation and management and detailing at least the following three important system features: (1) receiving charter flight availability information, extracting charter flight data indicators and corresponding flight characteristics to create and populate a charter flight data record in the TAS database; (2) receiving user search requests, extracting relevant requested information and matching requested flights with available flight data stored in the charter flight data record in the TAS database as one-way leg matchings; and (3) receiving user search requests, extracting relevant requested information, and facilitating dual one-leg matching by trying to match user requests with other users' search requests, pending users' search requests, and/or unoccupied repositioning flights due to an earlier one-way leg flight match. Although these three system features will be mainly discussed in the context of the discussion of FIG. 2, it is to be understood that the TAS facilitates significant flexibility and aspects of the system and various TAS components may be configured to facilitate aggregation and processing of data in order to meet the needs of a variety of system users beyond a charter flight data implementation discussed herein. For example, the TAS may be configured to facilitate additional types of travel, freight transportation/shipping, real estate or any number of other implementations that facilitate managing different types of data.

As illustrated in FIG. 2 and according to an implementation of the system, the process is initiated when the TAS receives or obtains a charter data object (structured/non-structured flight availability information) in step 200. The TAS retrieves a series of charter data identification and extraction rules in step 210 and extracts the charter flight data characteristics in step 220. Based on the source of the charter data object, as well as the quality of the extracted data characteristics, the TAS derives a data confidence metric 230. The confidence metric provides a system user with assurance that the extracted data corresponds to the availability information from a reputable provider or the flight data characteristics may have been confirmed by a system administrator. The flight data characteristics and confidence metric are then used to populate a charter flight data record in step 240. The charter flight data record is then used to populate the TAS database with available flight data.

After the TAS database has been populated, system users may submit a flight data search request in step 250. The flight data search request may be based on three primary flight parameters—requested flight equipment, time and location. The TAS extracts the charter data search parameters 255 and conducts a search of the available charter flight database in step 260. The TAS may be configured to create initial search results that include a best match corresponding to the search request, as well as TAS generated alternate search results that provide alternate suggested results to the system user in step 270. Depending on the implementation, the system may be configured to conduct a dynamic update and/or dual one-leg charter facilitation to the search results. In the dynamic update, the system user may put down a deposit to hold a reservation for the best match. However, for a predetermined reservation period the system may periodically re-conduct the search. In this type of implementation, the TAS may be configured to notify a system user if a better match is identified in one of the subsequent searches in step 290. In the dual one-leg charter facilitation implementation, the system may flag the unoccupied return flight of the best match trip as a priority fill and may periodically conduct a search in order to identify a match for the unoccupied return of the best match trip. Once a match is identified for the unoccupied return trip, the system may inform the user of the updated match and of the adjusted lower fare. In some implementations, the system user may be given the opportunity to upgrade to the dynamic search result or dual one-leg facilitation without penalty.

As discussed, the TAS attempts to process data looking for certain indicators within a document. For example, charter flight information usually is formatted as a digital document that includes information about a single or multiple flights (an “indicator”). Generally, the information is distributed/published by a variety of sources (publishers). Some sources are well known and publish frequently. Other sources publish less frequently and new sources might be added at any time. Some examples of indicators include: a name of a charter flight operator; company, name, address, phone number, web site and email of contact; a particular plane type, name, model, etc; a departure date, availability range of dates; airport base of departure (name of City, airport name, airport code); and/or a destination (city, region, country, airport name or code). These indicators are simply examples supplied within the charter flight industry. It is to be understood that the invention may be configured and applied to identify indicators associated with other industries, as well as location information associated with worldwide cities, regions, countries, states/provinces, etc.

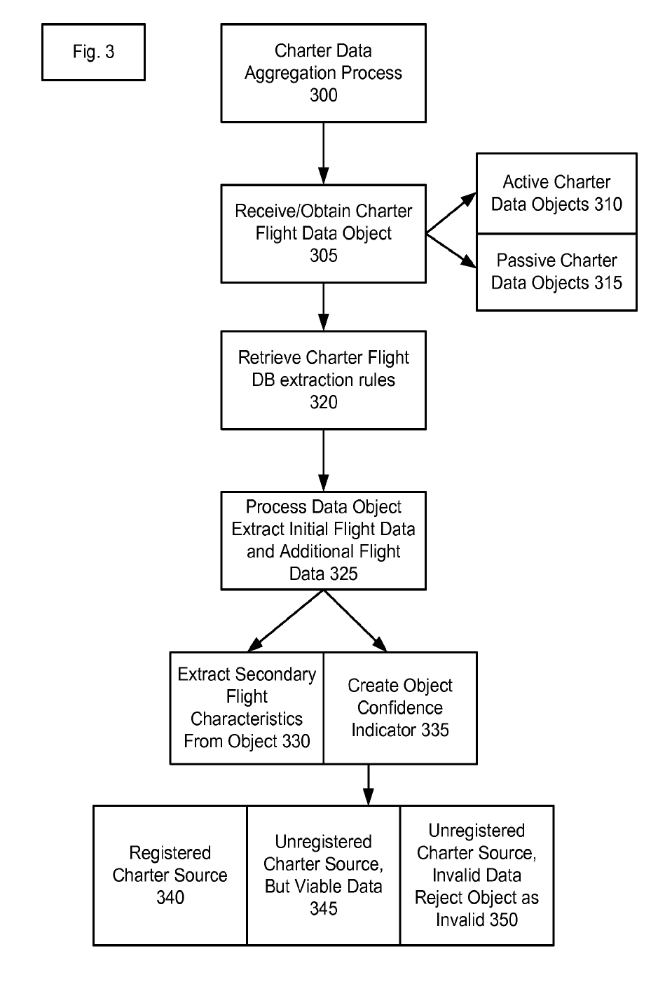

FIG. 3 illustrates aspects of the charter data aggregation process 300 according to an implementation of the TAS. The process is initiated when the TAS receives/obtains a charter flight data object. Based on the implementation, the process may involve passive receipt 315 of data objects or active search 310 data objects. Once the TAS has the data object, the charter data characteristic extraction rules are retrieved in step 320 for processing the data object. The extraction rules are established by a system administrator and may be iteratively refined to focus on certain charter data characteristics. In FIG. 3, the TAS extraction process identifies an initial flight indicator in step 325. As will be discussed in greater detail below, the TAS may coordinate the extraction with any of a number of flight indicators stored in the TAS database or established by a TAS system administrator. Information about flights is usually received as some type of document (ASCII, HTML, email or fax of a printed availability record). Initially, the TAS may be configured with the following information databases and implement any one or more alone or in combination as keys to correlate an initial flight indicator (i.e., the initial hook into a data object that indicates the object includes viable flight data):
Database of airports, their cities and airport codes
Database of charter plane companies, names and models
Longitude and latitude for all regional information
Database of date formats and date related keywords
Dictionary of relevant indicators or keywords and synonyms.

Once the initial flight indicator is identified, additional flight characteristics associated with the indicator are extracted. Moreover, the TAS may be configured to extract additional flight indicators and any corresponding flight characteristics in step 330. In step 335, the TAS creates an object confidence indicator. In FIG. 3, three possible confidence indicators may be created—a confidence indicator that indicates the underlying source of the data object is a charter source that has registered with the TAS; a confidence indicator that indicates the source is not a registered source, but enough flight data has been extracted to indicate the data is viable; and a confidence indicator that indicates the source is not a registered source and the data is not in a viable data format. If a data object is correlated with this last type of indicator, often the data object will be rejected as invalid, unless a system administrator overrides the TAS. In the context of the TAS, airport routes (one-way legs) detection is the most important information used for aggregation since users will search for flight routes. Even when the confidence of a possible flight object detected during the analysis is very low or the complimentary information (dates, contacts, etc.) are not well detected the TAS can be configured to store these improbable flight routes without elimination. When a user searches for a flight route, many improbable routes are eliminated by the query and results are usually displayed by confidence ranking

The TAS may implement a variety of rules to determine the confidence indicator. For example, some basic rules may include processing the following numbered elements.
1. Content of a single flight
   Dates must be today or in the future. Some keywords (i.e.: tomorrow) must also be detected as dates
   Each possible data fields of a flight record will be searched and identified using formatting rules, keyword proximity rules and the order and number of occurrences of the keyword's appearances
2. Detecting the presence of one or more flights in a document
   If there are more than 2 airport codes or names, there is probably more than one flight in the document
   Flights come in pairs: departure and destination
   When pairs of airports are detected, they may follow industry conventions. If it is the case, scoring will be increased for the detected flight.
   Flights have some expected data fields to be valid
   Individual records of flights in list of flights are identified through:
      Rules based on the proximity of words identified as flight fields
      The number of occurrences of possible flight record fields occurrences
3. Ranking of the content
   Multiple content rules rank the content based on detected industry keywords, keyword pairs proximity to each order (depending on characters and line breaks), industry specific keywords, pattern matching for common nomenclature and confidence of keywords based on industry vs. non-industry specific usage
   Content is ranked based on information supplied by users to the system
   Content is also ranked based on accuracy feedback supplied from the expert user
   Ranking also depends on past results for similar analyzed content
   The recency of a flight record increases its value.
4. Other rules
   If the format of a new document matches the format of a previously received document from the same source, then the degree of confidence in the exactitude of the information will match previous degrees of confidence. If the previous degree of confidence was 100%, then the extraction's exactitude should be 100%.
   A library of known formats will be built for formats where most flight record fields can be identified from their variance in multiple occurrences of a format. Differences between different formats can also be determined by the user/developer by identifying pertinent data flight record fields in digital documents.
   Templates can also be defined for messages not generated by humans originating from a known and detectable source. For these, flight information can be extracted with 100% confidence and changes to the format can generate alerts to adapt the detection template to future changes.
5. Rejecting content. If some invalid documents that contain no flights are submitted to the system, they must be eliminated or put aside without impacting the correctness of the system.
   Some keywords, like flight codes, have more value in the ranking of pertinent information.
   Some keywords, like dates, can have less value if they are not present with other words (flight codes)
   Each keyword category will be rated and ranked to establish a scoring to determine if a document should be rejected
   If there are only a few basic constituents elements in a document and no flight codes, it is probably not a pertinent document and should be ignored
   The same kind of rule can be applied to regions of a document in order to rate regions for relevance. Some ranked text regions can be combined with other ranked text segments and other rules to complement the ranking of a document. For example, flight dates or cities might only be specified once in a document that lists many flights.

The algorithm can detect many flights in a human written message and most of these are invalid. However, these will be filtered out when the score is zero. Additionally, the algorithm will detect possible flights that in reality are invalid. However, these will be filtered out by the following means:
Since users will search for specific flights, for example, for a route between 2 airports, other routes will not be displayed. Therefore, every unusual route a human would not take usually corresponds to an invalidly detected route. Testing and usage of the system has proven that this filters out most of the invalidly detected routes so that those remaining to be displayed are valid or possibly valid.
The search engine will present most relevant match and sort them by scoring. Thus, valid flights will be presented first.
If for a query, some possible flights are displayed, the part of the parsed message corresponding to the flight information is displayed in the search results so that the user can visually and rapidly identify if the flight is valid.

The rules can be adjusted and enriched from user intervention. The user can supply additional content through the addition of an industry context-specific expert system to prioritize its rules and analysis. This user can be a developer or an industry expert that trains the system from numerous available documents. Depending on the needs of a particular system user, the system may be configured to:
1. Verify if all fields matched?
2. Train the system by indicating the right information for non-matched fields;
3. Identify incorrectly matched fields: for example, the city for a flight arrival or departure could be mistaken with the city of a contact's information;
4. List of preferred and less preferred companies;
5. Flag airports that are never used or rarely needed by the users;
6. List of preferred and less preferred contacts.
   Based on the confidence scoring assigned to detected flights, user-defined thresholds will help identify flights that are viable, possibly viable and/or invalid.

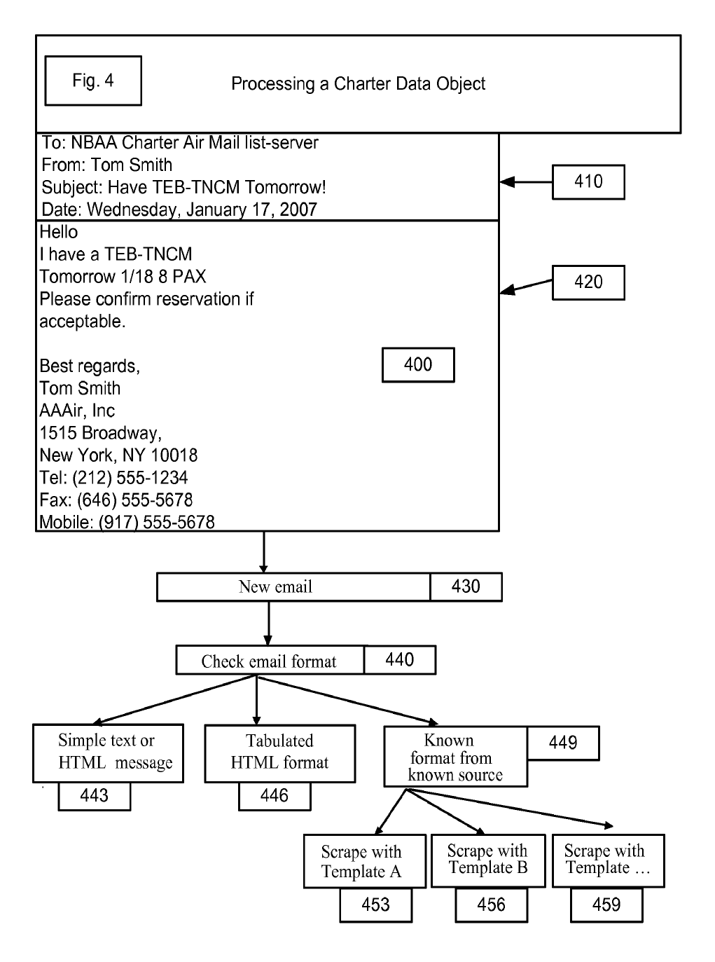

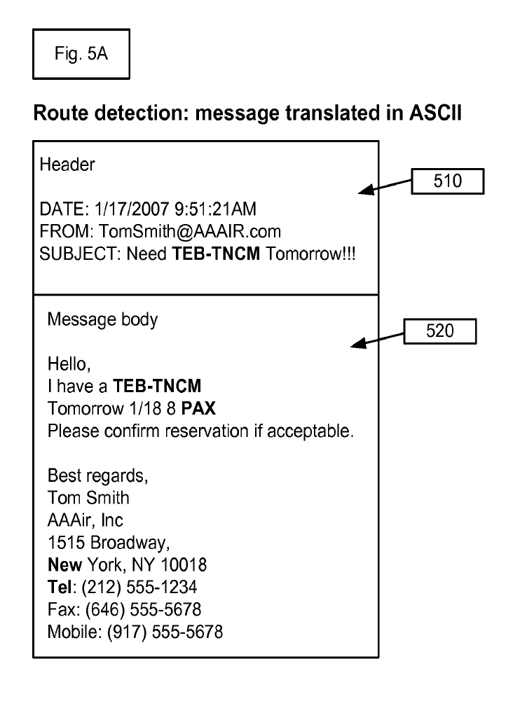

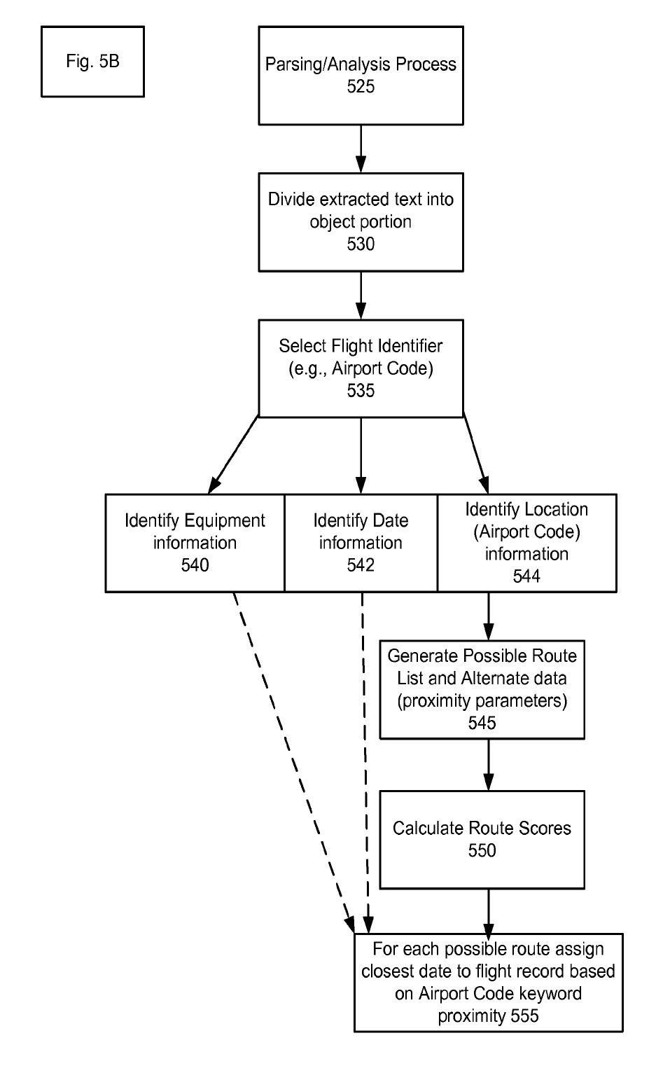

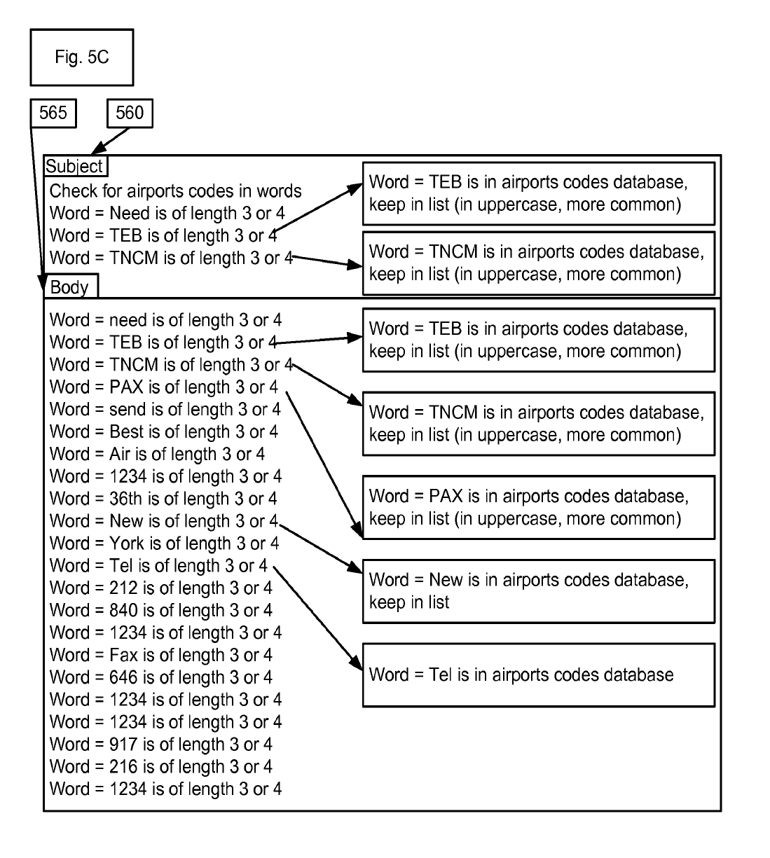

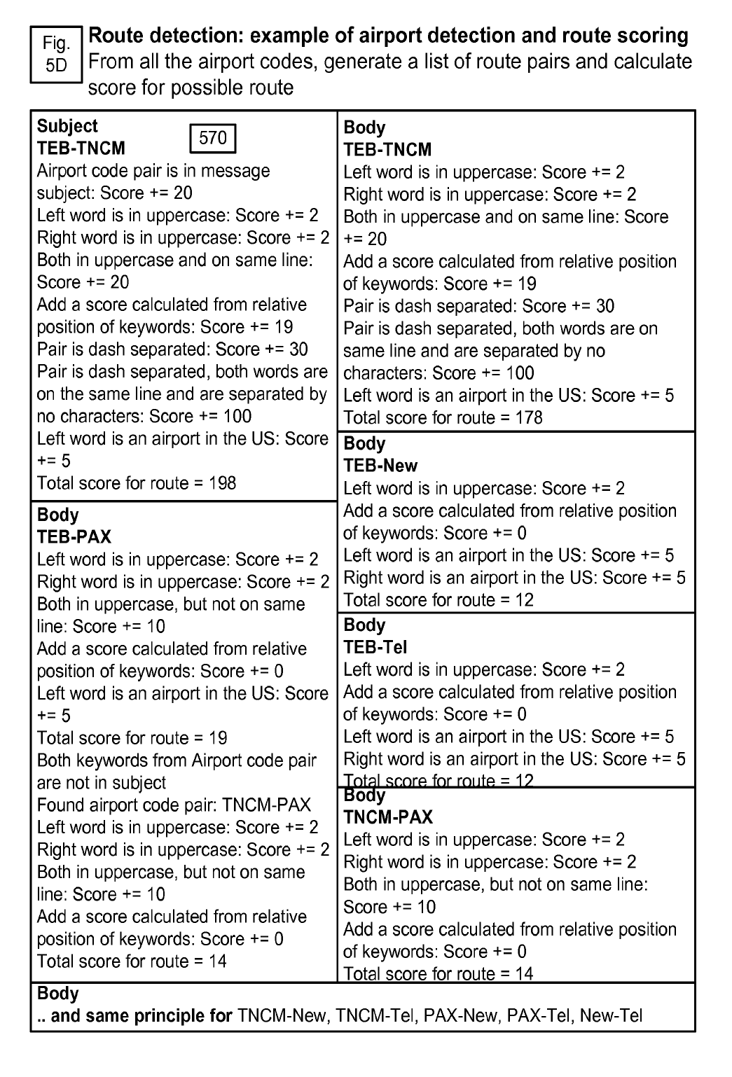

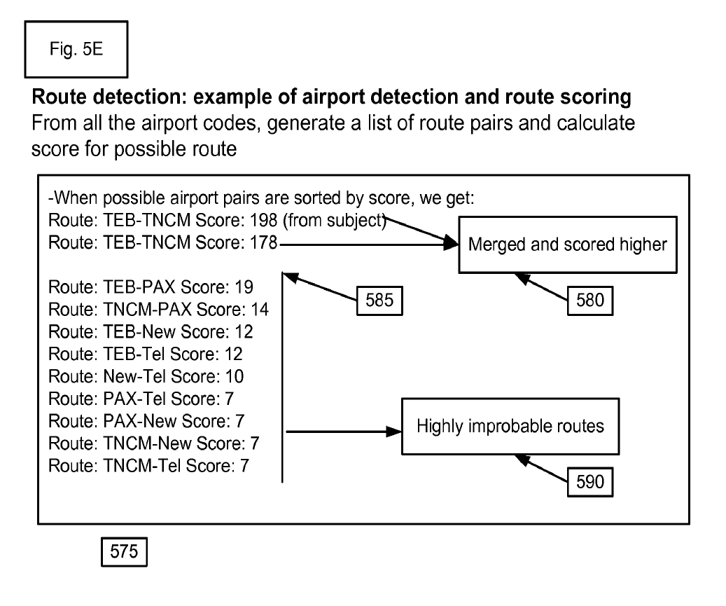

As part of the data confidence check, there are several additional situations that may result in the TAS identifying a record as non-viable. It is noted that the travel dates must be for current or future travel. Also, the TAS may be configured to recognize keywords (i.e., tomorrow) in coordination with the date of the charter object, which may also be used as indicators to complement the flight information with actual dates during data object processing. Each possible data fields of a flight record will be searched and identified using formatting rules, keyword proximity rules and the order and number of occurrences of the keyword's appearances. This process is described in greater detail below with regard to FIGS. 4-5E.

Also, if there are more than 2 airport codes or names, there may be more than one flight in the document. Generally, flights are discussed in pairs corresponding to departure and destination locations. Multiple flights data extraction may also have some expected data qualifiers/identifiers (fields) that establish a system threshold to qualify as a viable charter object. More specifically, individual records of flights in list of flights are identified through: (a) rules based on the proximity of words identified as flight fields; and (b) the number of occurrences of possible flight record fields occurrences. The data is ranked (verified) based on confidence rules, information supplied to the TAS, and/or on accuracy feedback supplied from the system administrator 140 (from FIG. 1). The TAS may also conduct ranking/verification based on historical results that contain similar analyzed content, as well as how recent the flight date is.

Additional veracity rules include analyzing the document format. If the format of a new document matches the format of a previously received document from the same (verified) source, then the degree of confidence in the exactitude of the information will match previous degrees of confidence. If the previous degree of confidence was 100%, then the extracted data should also be 100%. A library of known formats can be created and maintained where most flight record fields can be identified as variants of stored formats in the TAS database.

Variants may also be identified by correlating the user/developer by identifying pertinent data flight record fields in digital documents. Moreover, in determining the confidence metric, different parameters may be assigned different weights. Some keywords flight indicators, like airport codes, have more value in the ranking of pertinent information. Some keywords, like dates, can have less value if they are not present with other words (airport codes). Each keyword category will be rated and ranked to establish a scoring to determine if a document should be rejected. If there are only a few basic constituent elements in a document and no flight codes, it is probably not a pertinent document and should be ignored.

The same kind of rule can be applied to regions of a document in order to rate regions for relevance. For example, extracted header information may be weighted more than extracted body information. Also, some ranked text regions can be combined with other ranked text segments and other rules to complement the ranking of a document. For example, flight dates or cities might only be specified once in a document that lists many flights. A system administrator 140 can supplement/enhance/modify or create/delete extraction rules. Alternately, in some embodiments, a user can supply additional content to the expert system to prioritize its rules and analysis. In some implementations an administrator may be a developer or an industry expert that trains the system from numerous available documents. Some possible administrator rules include whether certain/all data fields matched or listing preferred (or excluded) companies and/or contacts.

FIG. 4 illustrates an example of a charter data object that includes flight availability information, whereas FIGS. 5A-5E illustrate aspects of the various processing steps on the example charter data object. In FIG. 4, the charter data object 400 is illustrated with an email format. As discussed above, the TAS may implement a passive charter object search—for example, subscribing to an email list server to receive flight availability information. In FIG. 4, the charter data object is configured as an availability email object 400. The email 400 object may be divided into header information 410 and body information 420. Depending on the implementation, data flight data extracted from one part of the object may be valued differently from data extracted from another part of the email object.

Also, FIG. 4 illustrates aspects of a processing overview for email charter objects. The TAS identifies the charter object as a new email in step 430 and checks for the email format in step 440. Step 440 is an important part of the TAS confidence metric derivation process. As illustrated in FIG. 4, the TAS checks to see if the data object is in simple text format or an HTML message 443, a tabulated HTML format 446 or is identifiable as a known format from a registered source 449. In the event that the TAS recognizes the object format as from a registered source 449, the TAS may select a stored set of parsing rules that it may use to extract a flight identifier and flight characteristics from the object. For example, the TAS may have templates A (453), B (456) and C (459) that correspond to data objects from registered sources A, B and C. These templates are used to create the raw data that is processed in determining whether the object contains viable flight data described below.

FIG. 5A illustrates aspects of the initial processing step when no template 453-459 has been matched to the data object and it has been determined that the message is a simple text or HTML message 443. Tabulated HTML or other document formats (e.g., word document, pdf, etc.) may be analyzed using similar principle as those described but with differences to account for the various file formats and/or layout of the text within a digital document. The TAS extracts the raw text from the email for processing but maintains two different text portions for analysis—text from header 510 and text from body 520. Once the raw text is extracted, the TAS proceeds with parsing the text to extract possible flight identifiers as illustrated in FIG. 5B. The text parsing/analysis process 525 starts with dividing the raw text into the original object portions for parsing (e.g., header text remains in the header section 510 and body text remains in the body section 520). This partition may be used later in the analysis to assist in determining the confidence metric. The parsing tool identifies which keyword will serve as a flight identifier for the purposes of an analysis run in step 535. For the purposes of this discussion, the Airport code 544 has been designated as the keyword flight indicator the parser is looking for. It is to be understood however, that depending on the source/type of data object and/or the particular needs of a system user the keyword flight indicator may be designated as date information (542). Equipment information (540) or a number of other parameters that may appear in charter data objects may also be used as a flight identifier. These other keywords (540, 542) can also be detected, just after step 530 and processed in parallel with the airport code to further assist with the route detection process (535). Accordingly, the steps 535, 540, 542, 544 (branch that includes 545,550) can all be done in parallel and lead to 555. Based on the keyword flight indicator, the TAS then generates a possible route listing and extracts flight characteristics in step 545.

In some implementations, the TAS uses word proximity as a correlation factor in matching flight characteristics with a flight indicator. Once the listing is generated, each possible route is scored according to a scoring template associated with the charter data source/data object in step 550. Once the viable routes are identified, the flight date information and additional flight characteristics are associated with the indicator based on keyword proximity or context in step 555.

FIG. 5C illustrates an example of how the keyword identifier is parsed within the raw text for the two portions of charter data object. In FIG. 5C the keyword identifier is a 3 or 4 letter word known as the airport code (every airport in the world is associated with a unique airport code, for example LaGuardia Airport in New York city corresponds with LGA). Accordingly, all 3 or 4 letter words are identified in the subject portion 560 and the body portion 565 of the charter object are identified. As shown, words “Need”, “TEB” and “TNCM” qualify as 3 or 4 letter words. These words may then be compared with the airport code database entries held within the TAS database.

FIG. 5D illustrates aspects of the airport code pairing and scoring process conducted to determine whether the charter object include viable charter flight route information. For example, each of the hits from the previous step (e.g., “TEB” or “TNCM”) is matched with another hit and contextually analyzed to determine a relative score for the proposed route. For example, in FIG. 5D “TEB” and TNCM” are identified and paired for further analysis as a subject pair 570. The analysis is based on adding points to a net score if certain constraints are met.

For example, because the airport code pair is in message subject portion the proposed route's score is increased by 20 points. Because the each of the left word and the right word in the pair is in uppercase, the route score is increased by 4 points. Furthermore, because both words in the pair are in uppercase and on the same line, the score is increased by an additional 20 points. Generally, the more indicative the characteristic is of an actual flight route, the more the score for the pair is increased. For example, because the pair is separated by a dash, both words are on the same line and there are no other characters separating the pair, the score is increased by 100 points. This feature is highly indicative of a viable route in the context of terminology standards for aviation.

FIG. 5E illustrates aspects of the scoring routine, wherein the score for each proposed pair identified in FIG. 5E is compared. The TAS creates a listing of all possible pairs and its corresponding score 575. If a pair appears in both the subject and the body portions of the record the pair scores are merged. The combined score 580 is used to determine whether the pair qualifies as viable flight data. Depending on the implementation and the scoring rules implemented by the TAS, there is a viability threshold 585 that is the effective cutoff for a pair to qualify as viable flight data. As illustrated in FIG. 5E, flight below the cutoff are designated as highly improbable routes 590. The process may be automated with the system eliminated proposed routes that fall below the threshold or the viable route designation may be achieved visually by a system administrator once all of the routes have been scored.

Furthermore, in some embodiments the system may implement additional filters that exclude proposed pairs where the distance between airports is too short. Alternately, the score may be reduced or eliminated if the airport is too remote, a military airport, or not relevant for the requested/available flight equipment. Date detection may be accomplished by pattern matching, prioritizing patterns, or textual position relative to proposed routes.

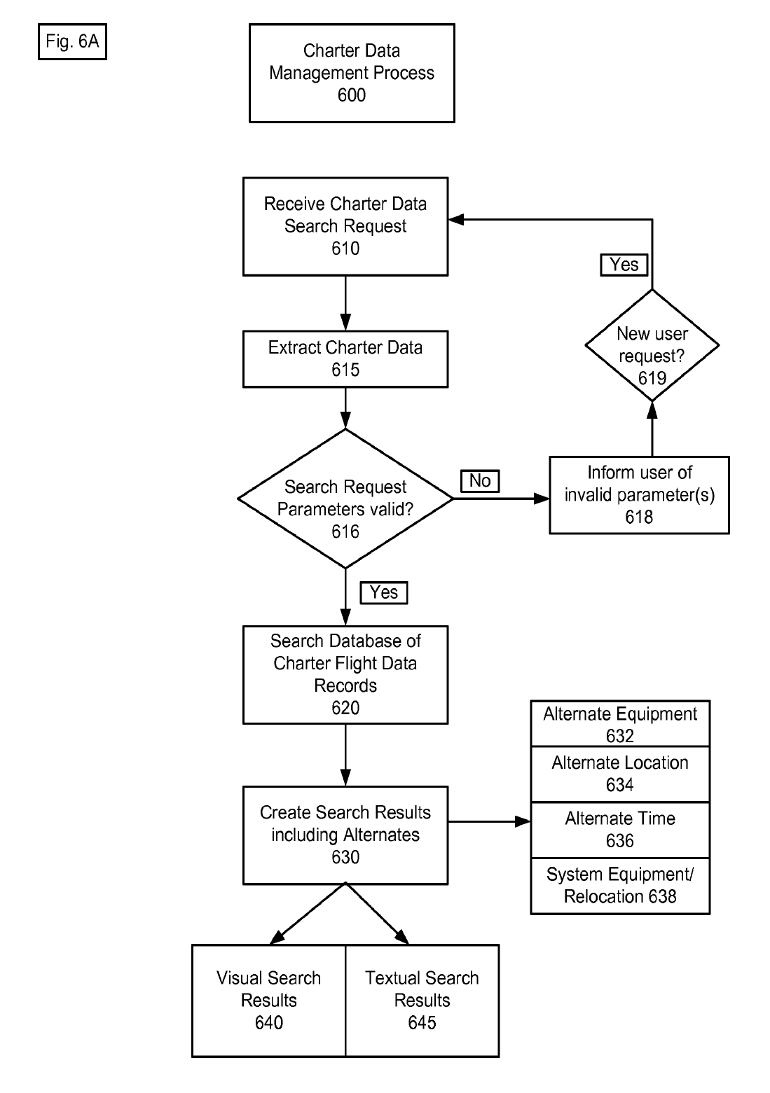

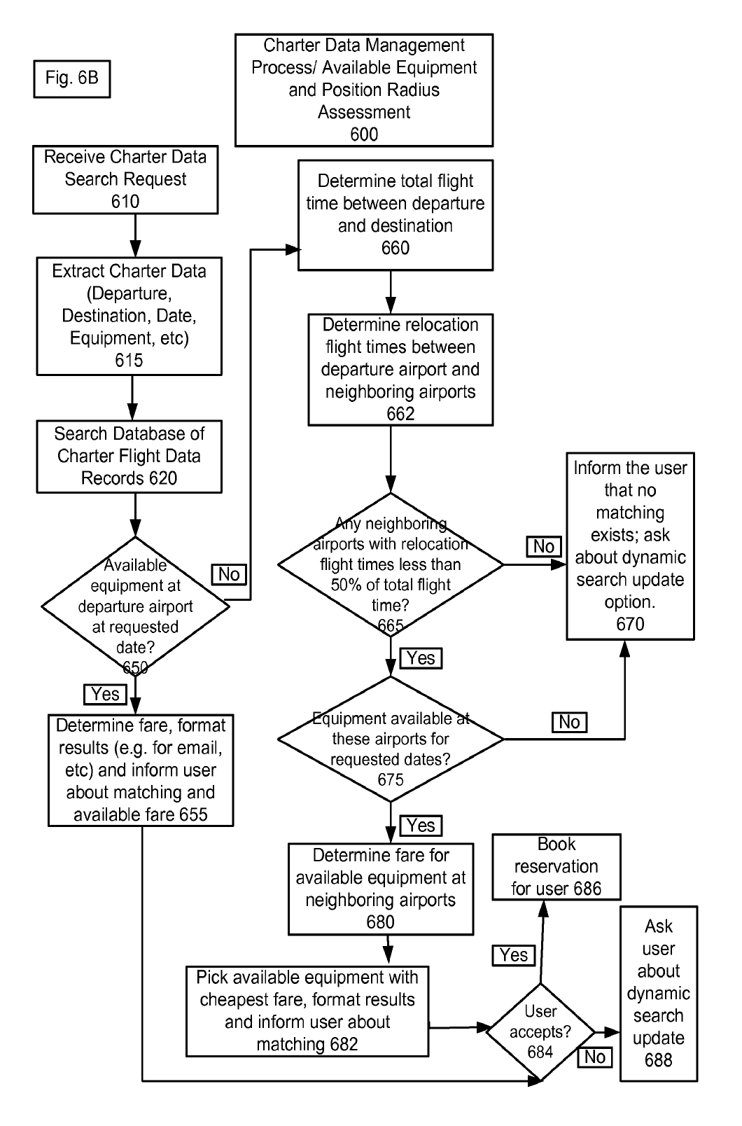

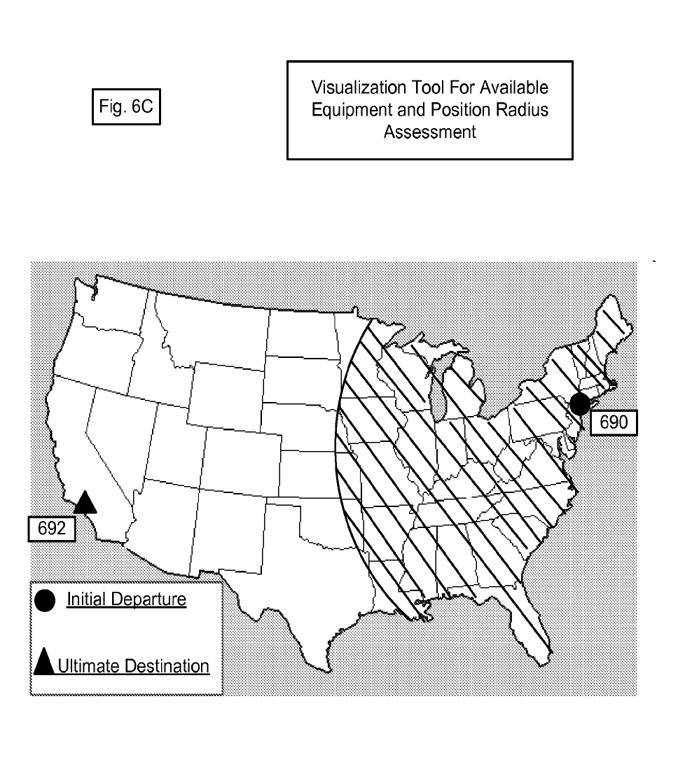

FIG. 6A is a high-level flow diagram illustrating aspects of the flight request processing according to an embodiment of the invention. The process is initiated when a system user accesses the system and creates a charter data search request in step 610. In an implementation, the system user may log onto the system and utilize a visual or textual search request interface in order to create a search request. Alternately, the system user may create a charter data search request and forward it to a service provider, who may in turn forward the request to the TAS to check availability in step 610.

Once the search request is received, the system may process the search request to extract a search keyword 615 for use in matching the request to an available flight record in step 620. Depending on the implementation, the TAS may use search request flight equipment characteristics, flight departure/destination location characteristics, flight departure/destination time characteristics to key the search of availability flight records. In one implementation, once the search keywords/parameters are extracted 615, the TAS may determine if the request parameters are valid 616. For example, the TAS may check to see that the requested travel dates are in the future, that the departure and destination locations correspond to existing airports, and that the requested equipment could potentially be available, i.e., the requested airplane is among the list of available airplanes. If at least one of the search parameters is invalid 616, the TAS informs the user about the invalid parameter(s) 618 and allows the user to submit a new valid request 619. If, however, all search parameters are valid 616, the TAS searches the charter flight records database 620 and creates a search result listing identifying a best match, as well as ranked alternates to the best match 630. The alternates may be ranked according to alternate equipment parameters 632, alternate location parameters 634, alternate time parameters 636, or alternate equipment relocation parameters 638. The equipment relocation parameters 638 illustrate the additional cost that would be involved in relocating near-by equipment that could satisfy the search request parameters.

Based on the needs of a particular system user, some implementations of the TAS may be configured with certain capabilities such as processing a search request based on user and/or system defined search terms or user and/or system defined rules for suggesting alternate results. For example, depending on the needs of the user and/or the precision of the departing time requested and the region or airport requested, the TAS may be configured to determine certain number of possible calculations:
For a search request, aircrafts that are available are identified and matched with empty legs for the day and/or time of the request.
Check coverage:
   Estimate length of flight and flight time using the latitude and longitude of the airports
   Compare coverage minimum with flight time
Check for the aircrafts' real-time position to see if some could be repositioned to match the request:
   Using tail number, the system links the base airport and calculates the distance and time of flight to nearest airports.
   Verify areas of transits
   Calculate if repositioning time is less than 50% of the flight time between point A and point B
To find additional matches for possible new flight departures, the system looks at the destinations of future one-way flights.
The system matches round trip flight requests with two one ways flights. Alternately, the system may match two one ways flights with a request with a round trip.

The TAS may also be configured to support the following features:
Sales representatives may receive alerts of new matches found for requests that have been received and matched to possible availabilities so that can further decide the best match for the customer and get a quote from the company making the flight available.
Search results can be:
   Sorted by freshness of data
   Displayed from best location to the worst locations (closest matches)
   Filtered by range (distance) or time (hours)
   Filtered by region
   Displayed visually using a mapping engine
      Furthermore, the TAS may be configured to maintain records of account information within a TAS database including: a list of companies and allows to list companies and view their details, including:
The type of aircrafts they have
Where they are based
Typical prices
Available flights from this company
Past activities with the company and satisfaction
   Moreover, the TAS's flexible Application Programming Interface (API) modules allow full integration with other software applications. For example, a CRM system might receive sales opportunities and send a request to the system, which will return results of possible flights availability. Some features of the API include capabilities to:
Retrieve, insert and modify aviation company data
Retrieve, insert and modify prospective flight requests
Synchronize companies, contacts, flight requests and available flight routes with external CRM systems
Initiate search for specific flight requests or flight availabilities and retrieve search results
Access the system to parse and understand unstructured flight information has it's own API which can be configured to fine-tune priorities of rules, add search and retrieval templates, add and modify keywords used, etc.

Visual indicators may show the level of confidence for each displayed records when the records originate from unstructured information that the system could not identify with certainty.

FIG. 6B illustrates aspects of assessing available equipment and position radius for a charter flight data implementation of the system that may be used to determine if repositioning of aircraft equipment is necessary to satisfy a particular user request. Once the user logs in TAS and submits a charter data search request 610, the system extracts charter data using provided data extraction rules 615 in order to discern requested departure and destination locations, requested travel time, requested aircraft equipment, and/or the like. Once the TAS validates all search parameters, it then searches the database of charter flight data records 620 to infer whether the requested aircraft equipment is available at the departure airport at the requested date 650. If there is equipment availability, the TAS determines the trip fare, format the search results (e.g., for textual, email, or visual representation) and informs the user about the matching flight and the available fare 655. If the user accepts the proposed matching 684, the TAS may book the reservation for the user 686. Otherwise, if the user does not accept the proposed matching, the TAS may ask the users if they are interested in receiving dynamic search update results 688. If the user decides to enroll in dynamic search updates, the system may require a user email address that can be used for delivering the future search updates. In a further implementation, the TAS may employ a user interface with a dynamic update search widget that may be used for delivering the future search updates to the user.

If, however, there is no availability of the requested aircraft equipment at the departure airport at the requested date 650, the TAS first determines the total flight time between the departure and destination locations 660, and then determines the relocation flight times between the departure airport and neighboring airports 662. The TAS then determines if the requested airplane equipment is available 675 at any of the neighboring airports with relocation flight time to the departure location of less than 50% of the total flight time 665. For example, if the requested flight time from New York (JFK) to Los Angeles takes approximately six hours, the TAS would determine the set of neighboring airports to JFK with relocation flight time of less than 3 hours.

FIG. 6C illustrates aspects of a visual system tool that may be used by a TAS system administrator in determining the set of airports with a relocation flight time of less than 50% of the total flight time. In this example, the departure airport is again JFK in New York 690 and the destination airport is Los Angeles International Airport (LAX) 692. All the airports that are located within the striped area of the map of the United States are within the three hour relocation flight time limit. So, any available charter equipment at airports within the striped area of the map of FIG. 6C would qualify for relocating to New York and then conducting the flight from JFK to LAX. As will be discussed later, the TAS may use additional parameters in determining the best match for a particular request.

In one implementation as that illustrated by FIG. 6B, if there is available equipment at these neighboring airports, the TAS determines the fare for all available equipment 680, picks the available equipment with the cheapest fare and informs the user about this matching 682. The user may accept the matching and request for a booking of the reservation 686, or he might reject the proposed matching in case which the system would propose to the user the option of using the dynamic search update feature 688. In another implementation, the TAS may allow the user to tentatively reserve the matching for a specified number of days by putting down an appropriate deposit. This may allow for dynamic search update facilitation and dual one-leg matching as discussed later. In a yet another implementation, the TAS may inform the user of the five cheapest equipment available at neighboring airports to the departure and allow the user to select the matching of his choice. If there are no neighboring airports with relocation flight time less than 50% of the total flight time 665, or if the requested equipment is not available 675 at any of the neighboring airports with relocation flight time of less than 50% of the total flight time, the TAS informs the user that no matching exists and asks the user if they are interested in receiving dynamic search update results 670. In further TAS implementations, sophisticated revenue management techniques are used in order to facilitate determination and readjustment of the described 50 percent relocation rule. For example, if there is information available about additional taxation policies in specific airports used as transit points, this information may be used in order to adjust the described 50% relocation flight time rule accordingly.

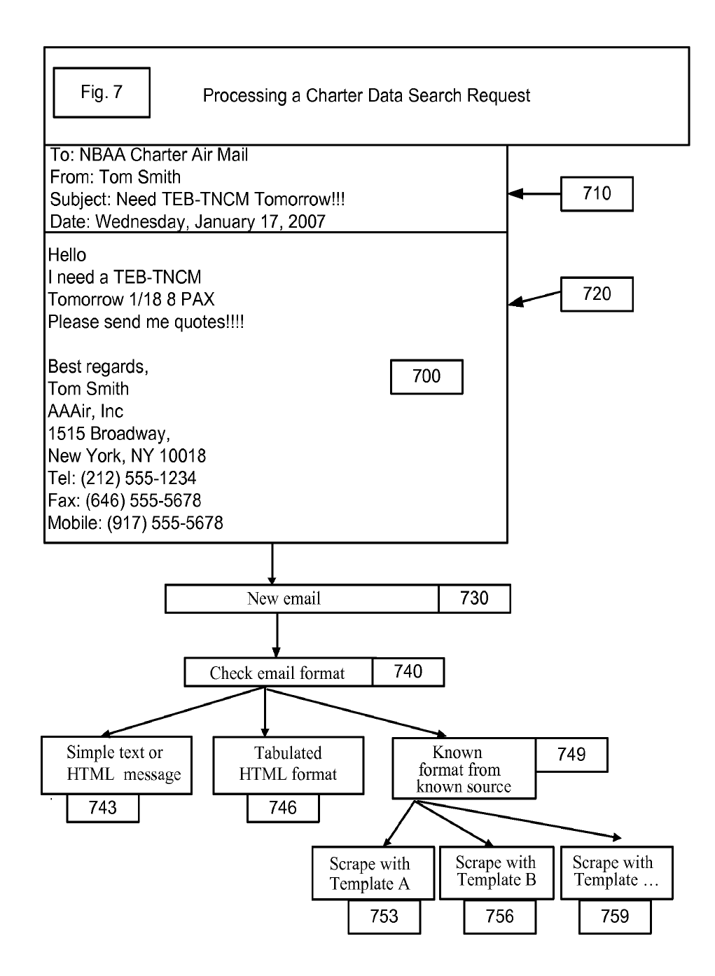

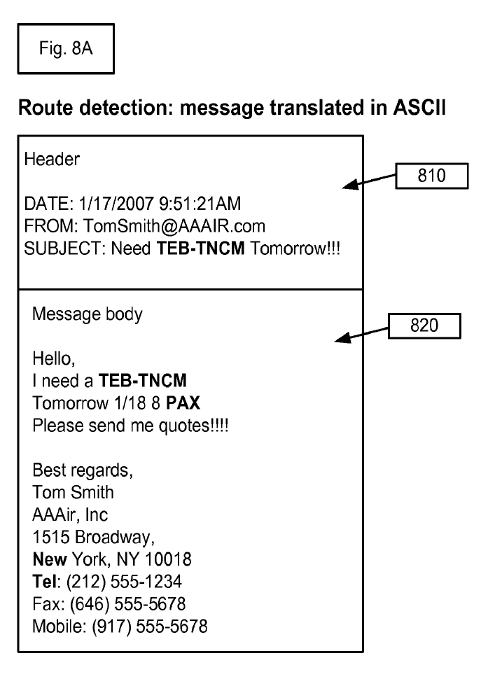

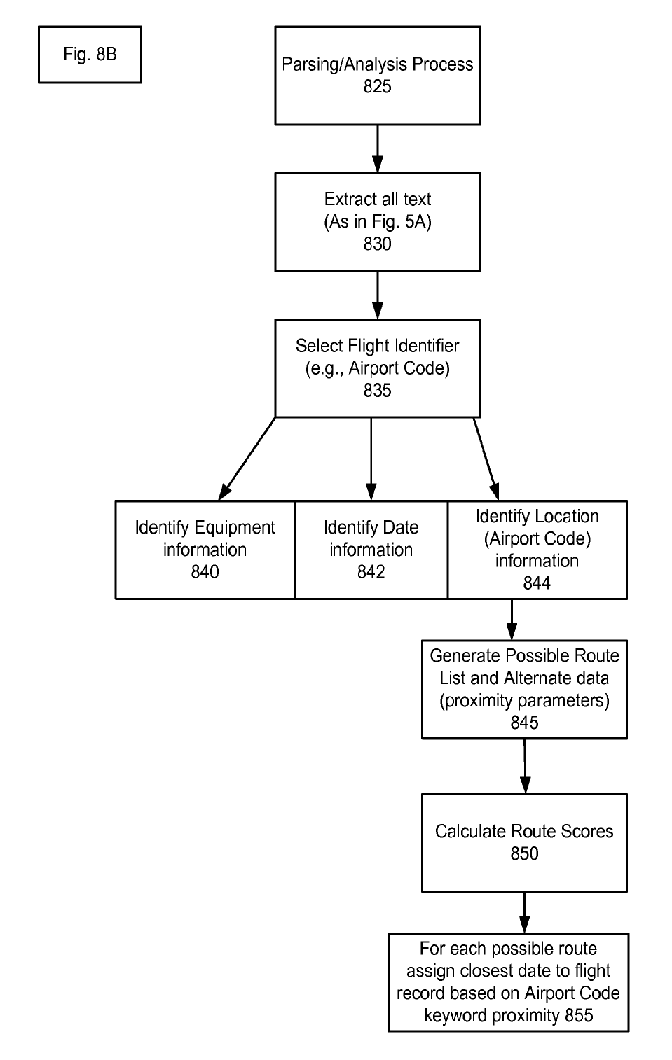

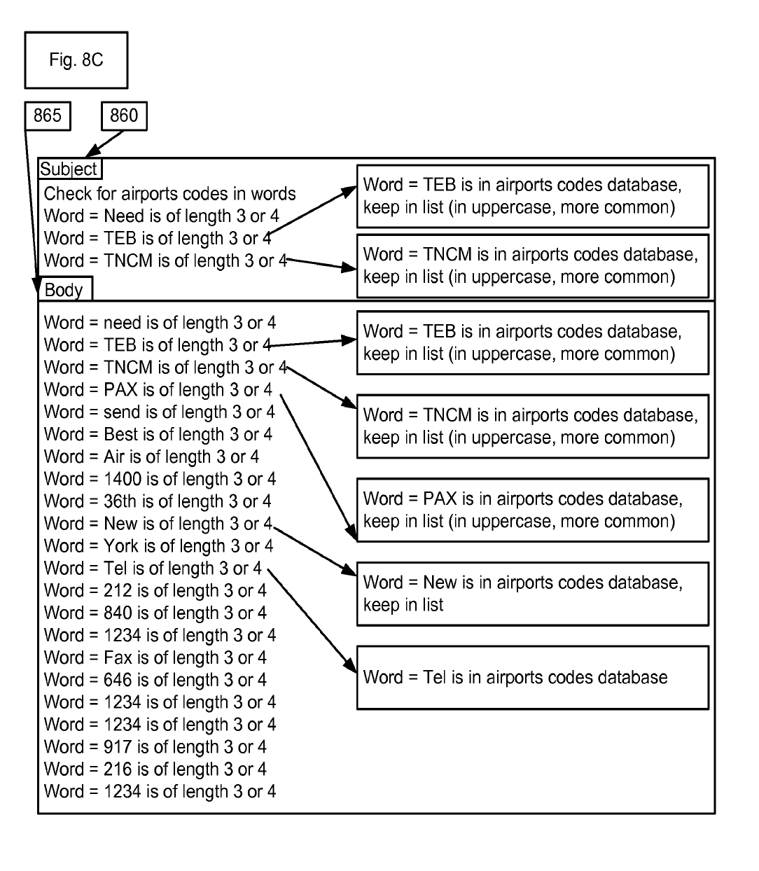

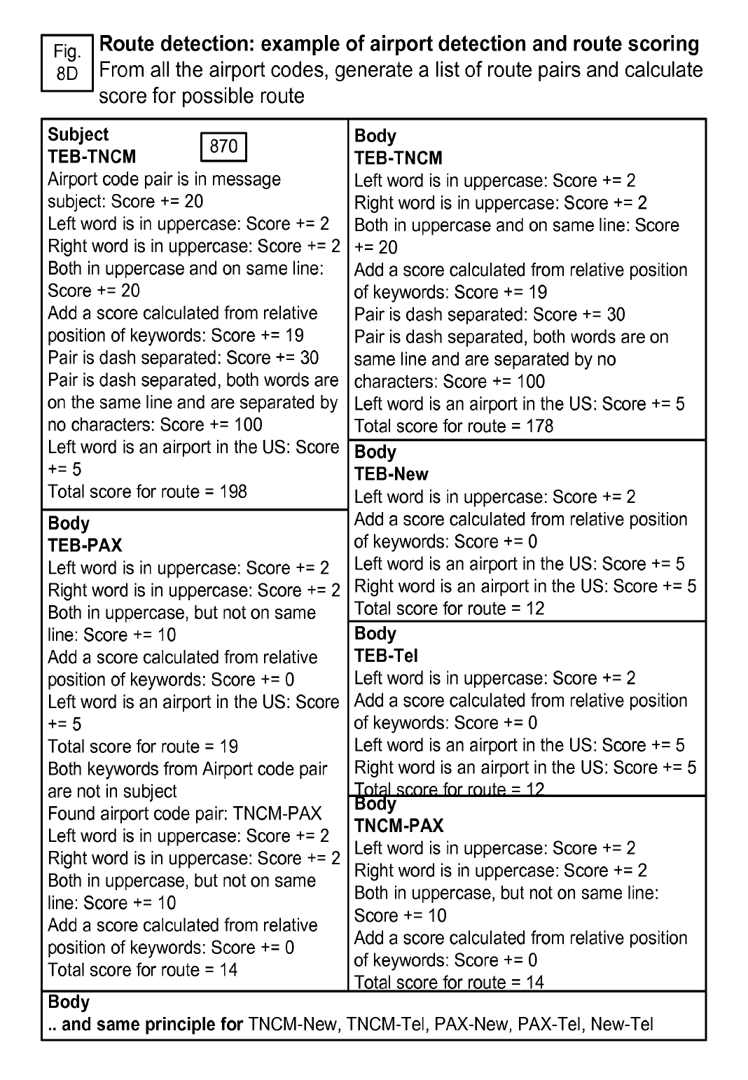

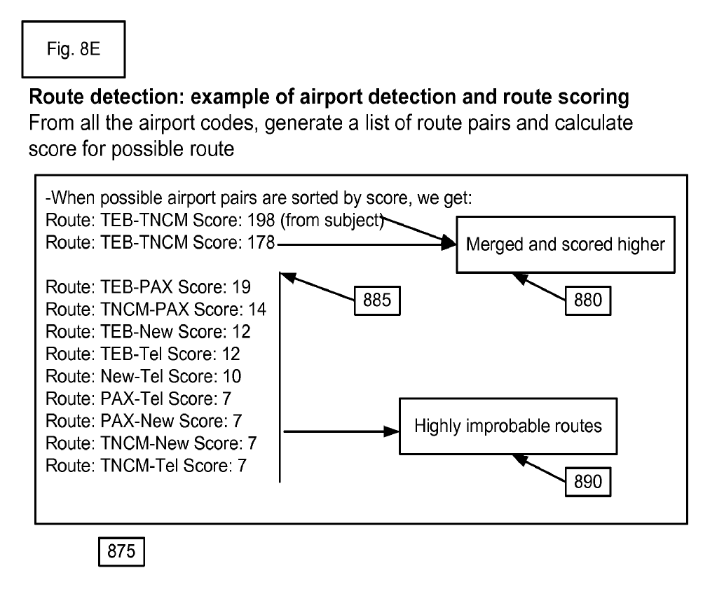

FIGS. 7 and 8A-8E illustrate aspects of another method of processing a search request according to an implementation of the TAS, where a charter data search request is received by the system. FIG. 7 illustrates the charter data search request configured as an email with a header 710 and a body 720. The email search request process is similar to that discussed above regarding the charter data object processing illustrated in FIGS. 4-5E. The email is received by the TAS in step 730 and subsequently checks the email format in step 740. Depending on the format, the TAS may apply a different set of data extraction rules. For example, the email may be configured as simple text or an HTML message 743, a Tabulated HTML format 746 or a known format from a registered data source. If the search request is from a registered source, the TAS may be able to apply a corresponding source-specific parsing template (Template A 753, Template B 756, or Template X 759).

FIG. 8A illustrates the first step once the email format has been identified—the TAS extracts the raw text from the email for processing but maintains two distinct text portions for analysis—text from header 810 and text from body 820. Once the raw text is extracted, the TAS proceeds with formatting and parsing the text to extract possible flight identifiers as illustrated in FIG. 8B. The text parsing/analysis process 825 starts with dividing the raw text into the original object portions for parsing (e.g., header text remains in the header section 810 and body text remains in the body section 820). The partitions may be used later in the analysis to assist in determining the confidence metric.

The parsing tool identifies which keyword will serve as a flight identifier for the purposes of an analysis run in step 835. For the purposes of this discussion, the airport code 844 has been designated as the keyword flight indicator the parser will use to match with potential search results. It is to be understood however, that depending on the source/type of data object and/or the particular needs of a system user, the keyword flight indicator may be designated as date information (842), equipment information (840) or a number of other parameters that may appear in charter data objects. Based on the keyword flight indicator, the TAS then generates a possible matched route listing and extracts flight characteristics in step 845. In some implementations, the TAS uses word proximity as a correlation factor in matching flight characteristics with a flight indicator.

Once the listing is generated, each possible route is scored according to a scoring template associated with the charter data source/data object in step 850. Once the viable routes are identified, the flight date information and additional flight characteristics are associated with the indicator based on keyword proximity in step 855.

FIG. 8C illustrates an example of how the keyword identifier is parsed within the raw text for two portions of charter data search request. In FIG. 8C, the keyword identifier is a 3 or 4 letter word known as the airport code (every airport is associated with a unique airport code—for example LaGuardia Airport in New York city corresponds is designated “LGA”). Accordingly, all 3 or 4 letter words in the subject portion 560 and the body portion 565 of the charter object are identified as possible airport codes. As shown in FIG. 8C, the raw text “Need”, “TEB” and “TNCM” qualify as 3 or 4 letter words. These words may then be compared with the airport code database entries stored within the TAS database.

FIG. 8D illustrates aspects of the airport code pairing and scoring process conducted to determine whether the charter object include viable charter flight route information. For example, each of the hits from the previous step (e.g., “TEB” or “TNCM”) is matched with another hit and contextually analyzed to determine a relative score for the proposed route. For example, in FIG. 8D “TEB” and “TNCM” are identified as a potential match and paired for further analysis as a subject pair 870. The scoring analysis is based on adding points to a net score if certain constraints are met.

For example, because the airport code pair is in message subject portion—the proposed route's score is increased by 20 points. Because each of the left word and the right word in the pair is in uppercase format independently, the route score is increased by 4 points. Furthermore, because both words in the pair are in uppercase and on the same line, the score is increased by an additional 20 points. Generally, the more indicative the characteristic is of an actual flight route, the more the score for the pair is increased. For example, because the pair is separated by a dash, both words are on the same line and there are no other characters separating the pair, the score is increased by 100 points. This feature is highly indicative of a viable route.

However, it is to be understood that although the figures are directed to an airport code scoring set, the TAS may be configured to implement scoring rules directed to analyze and score the raw text based on other key words related to equipment, departure/destination location, departure/destination time and/or other flight indicators.

FIG. 8E illustrates aspects of the scoring routine, wherein the score for each proposed pair identified in FIG. 8E is compared. The TAS creates a listing of all possible pairs and each pair's corresponding score 875. If a pair appears in both the subject and the body portions of the record, the pair scores are merged. For such pairs, the combined score 880 is used to determine whether the pair of indicators qualifies as viable flight data. Depending on the implementation and the scoring rules implemented by the TAS, there is a viability threshold 885 that is the effective cutoff for a pair to qualify as viable flight data. As illustrated in FIG. 8E, flights listed below the threshold are designated as highly improbable routes 890. The process may be automated with the system eliminating proposed routes that fall below the threshold. In the alternative, the viable route designation may be achieved visually by a system administrator once all of the routes have been scored. Furthermore, as part of a visual determination the system administrator may be provided with access to the underlying charter data search request to assist with their viability determination.

Furthermore, in some embodiments the TAS may implement additional filters that exclude proposed pairs where the distance between airports is too short. Alternately, the score may be reduced or eliminated if the airport is too remote, a military airport, or not relevant for the requested/available flight equipment. Date detection may be accomplished by pattern matching, prioritizing patterns, or textual position relative to proposed routes.

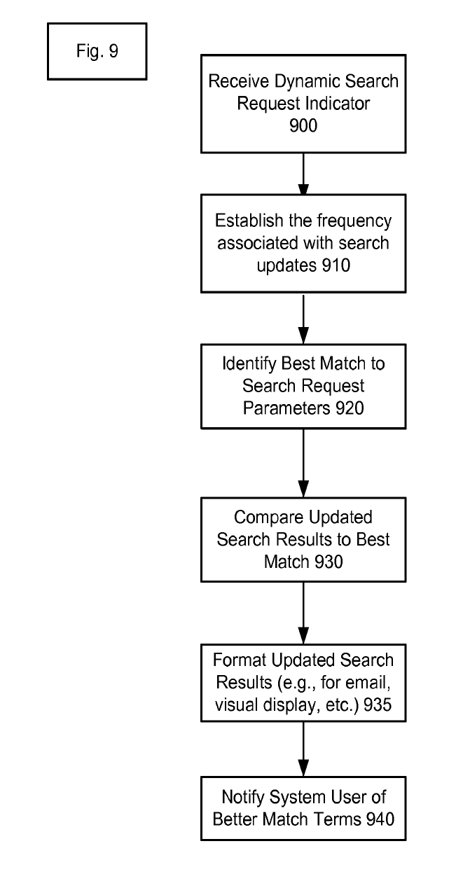

FIG. 9 is a flow diagram illustrating aspects of a dynamic search result update. Once the search request parameters have been extracted, the system conducts a search of the charter flight data records stored in the TAS database. The TAS generates a best match based on the available flight data record. In an implementation, the TAS is configured to store the best match parameters and re-attempt the search requests to determine if a better match is found for a user-specified period of time. In FIG. 9, the TAS receives a dynamic search request indicator as part of the initial search request in step 900. The TAS then establishes the frequency of the periodic update, i.e., how often a search of available records is performed in step 910. Both of these parameters are generally included as part of the search request (alternately they may be established for a registered system user during the system user registration process). The TAS associates the search request with the system user's account information and stores the search request/results information in the system database. The TAS also stores a copy of the best match from the initial search in step 920. The specific parameters of the best match and the initial search request are then compared to the updated search results in step 930. If a better match is found, the TAS formats 935 the updated search results for email, textual, or visual presentation and then notifies the system user of the terms associated with the better match in step 940.

Depending on the particular implementation, the new search results may be simply stored in the system database (in step 940) for review by a system user at a later time. Alternately, the system user (or administrator) may establish a set of comparison rules to only store the ‘best result’ from the periodic search updates. For example, the search request may define departure and destination cities, travel days, but may be optimized to keep the ‘best price’ result from the periodic searches for a user-determined length of time. The user may then access the periodic update storage modules to see if they would like to change/accept the new parameters, instead of the previous ‘best’ search result parameters. Alternately, the TAS may be configured to update the stored ‘best’ results and generate and transmit a user alert to notify the user of the updated search results, as in the step 940.

It is to be understood that the TAS facilitates significant flexibility and may incorporate additional features than the one-way leg matching discussed above. For example, some implementations may be configured to facilitate dual one-leg charter facilitation (DOCF). In DOCF implementations of the TAS, the system may be configured to accept service requests and attempt to match corresponding one-legs. For example, if system user A is offered a full fare one-leg from New York to Florida, user A may have to pay for the occupied flight from New York to Florida, as well as the repositioning unoccupied flight from Florida back to New York (or to another destination for the plane's next charter). Accordingly, there may be increases in revenue generation prospects, increases in equipment utilization rates, and/or reductions in user costs if the unoccupied flight from Florida back to New York is matched with a system user B, who has submitted a request for the Florida to New York flight within an acceptable time duration from the initial user A's New York to Florida flight.

In one implementation, facilities for user-directed DOCF may be provided, whereby a first user submitting a service request may be returned either or both of one-leg matches, which may have associated unoccupied return legs for which the first user may be charged, and/or unoccupied return legs of other users' one-leg service requests and/or reservations. In one implementation, discounts may be provided over ordinary one-leg reservations to the first user selecting the unoccupied return leg of a second user's one-leg service request. In one implementation, a user may input search settings via a user interface to decide which types of matches (i.e., one-leg matches, unoccupied return leg matches, etc.) will be included as search results in response to a user service request. In one implementation, users may also be permitted to advertise and/or sell their own unoccupied return legs to buyers seeking one-way charter flights. Selling users may receive the amount paid by the buyer of the unoccupied return leg, the amount paid by the buyer discounted by a subscription or transaction fee, a pre-set discount (and a system administrator receive the amount paid by the buyer), and/or the like.

In another implementation, system-directed DOCF may be implemented, whereby a plurality user service requests are aggregated and analyzed to discern matches based on pre-defined criteria. For example, in one implementation, the system may seek matches between unoccupied return legs of users' service requests with occupied legs of other user's service requests. In another implementation, the system may seek matches between equipment reserved in association with one-leg requests that don't necessarily have any unoccupied return leg commitments. For example, User A may have a travel reservation from New York to Florida and, under ordinary circumstances, the reserved plane would stay in Florida until a subsequent commitment was found to another location (e.g., back to New York). The system may, however, identify a match with User B who has a travel reservation from Florida to New York with a separate equipment provider (also with no unoccupied return leg commitment) and suggest a possible arrangement for User A and User B to use the same equipment provider in order to free up the other equipment provider for other reservations, cut down on costs, equipment wear, fuel usage, and/or the like. In one implementation, an incentive may be provided to the unused equipment provider to release a user from the existing reservation.

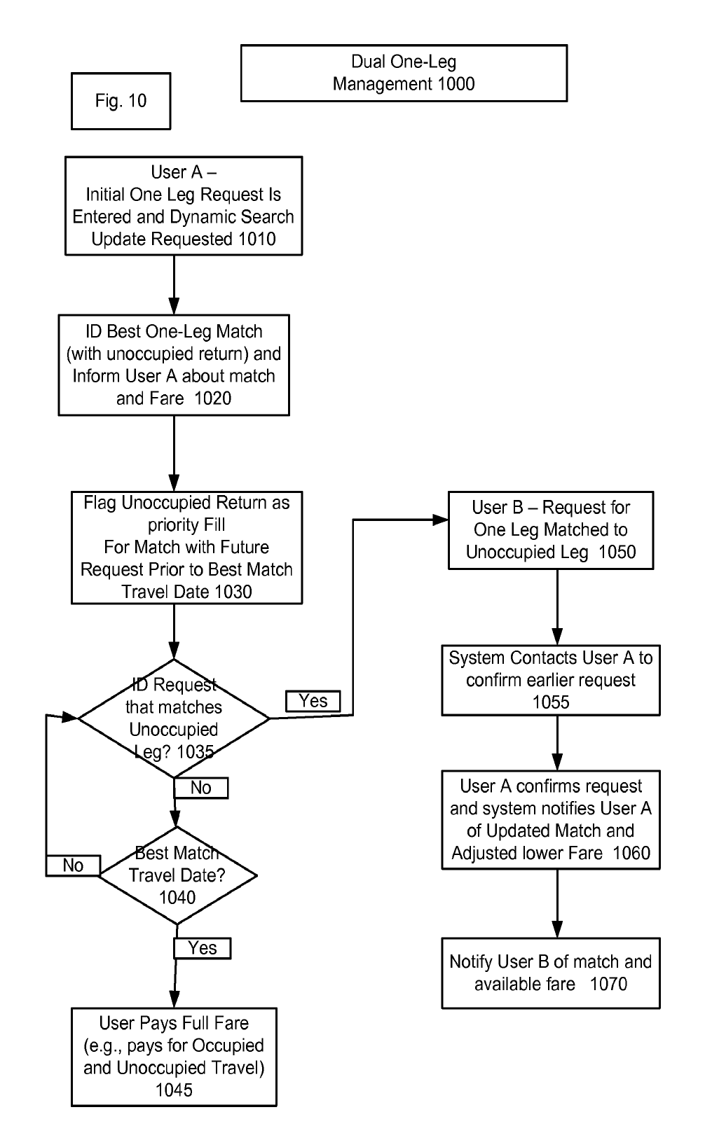

FIG. 10 illustrates aspects of DOCF. As illustrated in FIG. 10, User A may submit a service request 1010 (e.g., a request for charter service between New York and Florida). Depending on the implementation, User A may be able to request dynamic search update, which may be provided to certain subscribers, registered users as a base feature or as part of premium services. Application of dynamic search update facilities to the search request may cause User A's search query to be saved and periodically resubmitted (e.g., once every 15 minutes) to see if there are any updates to results matching the query. In various implementations, dynamic search updates may operate to periodically retrieve data pertaining to available flights in the direction of User A's travel request as well as, or alternatively, to retrieve data pertaining to demand for flights in the opposite direction of User A's travel request. In one implementation, the system may alert a system administrator to any uncovered matches, and the system administrator may then determine how and/or which matching service requests should be paired up such that associated users are notified of the existence of the match and/or provided the opportunity to take advantage thereof. In the implementation illustrated in FIG. 10, the system identifies the best one-leg full fare match 1020 (e.g., where User A pays for his occupied flight from New York to Florida, as well as the unoccupied repositioning flight to return the aircraft back to New York). As part of the DOCF dynamic search updates, the system may flag the unoccupied return flight as a priority fill for match with a future service request from another user before the flight travel date 1030. In an alternative implementation, the system may place the unoccupied return flight on equal or similar footing with other unoccupied return flights and/or other equipment availability postings for return in response to current and/or future user service requests and/or searches. In still another implementation, the user may be permitted to decide whether and/or how to place the unoccupied return flight up for advertisement and/or sale to current and/or future users.

The system may be configured to periodically query the TAS database to identify a matching service request for the unoccupied leg 1035. If the system does not ID a match by the time the User A's travel date arrives 1040, User A pays the full fare to cover both the occupied travel flight and the unoccupied repositioning flight 1045. Alternately, if the system matches the unoccupied leg with a second user's (e.g., User B) service request 1050, the system may be configured to contact User A to confirm the earlier request 1055, and upon a request confirmation, notify User A of the new match, as well as notify User A of a discount from the full fare 1060. The system may also notify user B of the match and the corresponding available fare.

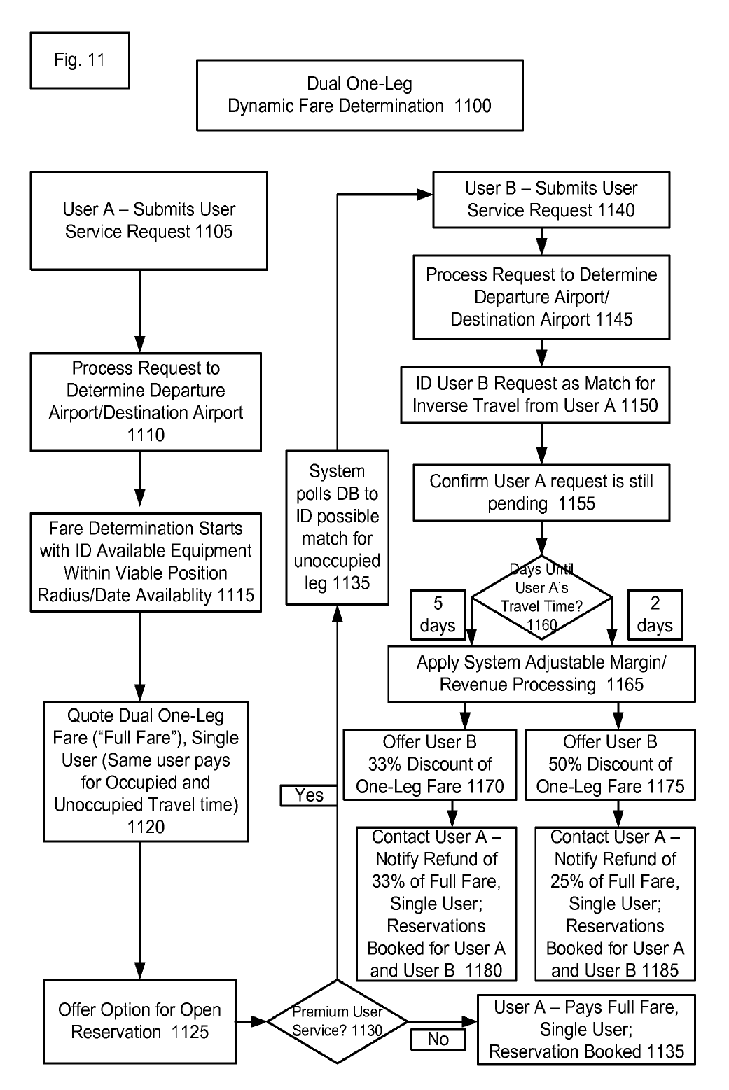

FIG. 11 illustrates additional aspects of DOCF. As discussed in the example from FIG. 10, User A submits a user service request 1105 (e.g., an email requesting a flight for 5 passengers from New York to Florida on April 1). The system may be configured to process the request to determine Departure/Destination airports 1110 in order to determine whether a match exists in the TAS databases or to set up a watch to determine if a matching request is received prior to the requested travel date. As part of request processing, the system may conduct a preliminary check to see if a complementary match, such as the unoccupied return leg of an existing one-way charter flight request and/or reservation, exists in the TAS databases. Alternately, as illustrated in the implementation of FIG. 11, the system may initiate a full fare determination that includes identifying available equipment within a viable position radius and with availability around the request travel date 1115, as described in FIG. 6C.

In FIG. 11, the system may return a quote for a dual one-leg fare or a “full fare”, wherein the single user pays for the occupied requested travel from New York to Florida, as well as an unoccupied repositioning flight back to New York or the next departure city for the particular aircraft 1120. Depending on the implementation, the system may offer User A the option to have an open reservation 1125 (e.g., where the system will save the user's query and periodically look for a match even if one does not exist at the time the service request is submitted by User A).

In some implementations, the system reserves matching services as a premium and/or subscription service. For example, in one implementation, the system may charge a user fee for the opportunity to post an unoccupied return leg of a reserved flight (either by the user himself or by a system administrator). In an alternative implementation, the system may charge a transaction fee for matching unoccupied legs of buyers' and sellers' service requests. In still another implementation, one-leg matching services may be included as part of free/base system features. In the implementation shown in FIG. 11, the system determines whether User A is a premium user 1130. If not, User A may be only offered the full fare (or, in an alternative implementation, a discounted matched fare, if one existed when User A submitted his request). If User A is a premium user 1130, the system may periodically poll the TAS database to identify possible matches for the unoccupied leg of User A's service request 1135. Although discussed as premium services, dynamic search may be implemented for all users. In one implementation, the system and/or User A may post and/or otherwise advertise the availability of the unoccupied return leg to a list of users, such as via an e-mail message sent to all users on an e-mail address list, updating a database to post the listing to requesting users and/or in response to search requests, and/or the like. In some implementations, the system may permit and/or implement periodic re-posting of the listing and/or marking of an ongoing listing as inactive when the flight is no longer available. In one implementation, the system may rebroadcast all outstanding unfulfilled requests, such as on an as-requested or periodic basis.

In FIG. 11, the system, after receiving 1140 and processing User B's service request 1145, identifies User B's service request as a match for User A after processing the service request 1150. A match may be established, for example, if User A's destination location is within a specified radius of User B's departure location. The system may further determine whether User B's destination location is within a specified radius of a selected target destination location, such as User A's original departure location or a third location amenable to the equipment provider. In another implementation, the system may determine a combined expected time, fuel usage, cost, and/or the like for User A's trip and User B's trip, assuming that both use the same equipment provider, and mark the request pair as a match if the total time, fuel usage, cost, and/or the like is less than a pre-defined threshold value.

Depending on the implementation, the system may be configured to confirm User A's request is still pending 1155, before providing discounts and/or incorporate system commission(s)/finder's fees to the matched fares. In FIG. 11, the system may be configured to determine and apply a discount based on the number of days remaining until the first user's (User A's) requested travel date 1160. As illustrated, there may be a deeper discount for fares as the travel date approaches (e.g., 5 days before the requested travel the discount may be set at 33% from the full fare for both users 1170, whereas 2 days before the requested travel the discount may be set at 50% from the full fare for User B and a 25% for User A 1175). If User A and User B accept the discounted fares, the reservations may be booked (1180, 1185). Alternately, if one of both users reject the discounted fares, the system may continue to search for a new match for the accepting user or simply start the process over if both users reject the discounted fares.

In a further implementation, a sophisticated pricing mechanism may be employed to determine the discounts extended to both users. For example, if the price of the one-leg fare is equal to Y, and the number of days remaining until User A's travel date is X, the following formulas may be used to calculate the adjusted fare prices for Users A and B:
User B Fare=maximum {Y, Y*[1−((5−X)/10)]}; and
User A Fare=2*Y−(User B Fare).

In this case, if the price of the one-leg fare Y=$200 and the number of days remaining until User A's travel date is five or more, User B's Fare would be $200. User B's Fare would decrease to $180, $160, $140, $120, and $100, when the number of days remaining until User A's travel date is four, three, two, one and zero respectively. User A's adjusted discounted fares would be $200, $220, $240, $260, $280, and $300, when the number of days remaining until User A's travel date is five or more, four, three, two, one and zero respectively. So, depending on the number of days separating User B's request and User A's travel date, this pricing and discount mechanism would enable the TAS to extend discounts to both users ranging from 0%-50%. In another implementations, the TAS's pricing and discount mechanism may be configured so that the sum of the fares of User A and User B is always above $400, ensuring in this way that the service provider (i.e., the TAS system administrator) profits directly from the charter data matching process. In a further implementation, the trip fares for User A and B may include a service provider commission which can be applied as a finder's fee, membership subscriptions, percentage discount fare margin, and/or the like.

It is to be understood although the examples discussed in FIGS. 10-12 are based on an occupied requested flight from New York to Florida and an unoccupied return flight from Florida to New York, the system may be configured to determine whether alternate aircraft provide a better match with unfulfilled service requests. For example, an aircraft that has a booking on April 6 from Phoenix to New York may be selected as a better match for a service request for travel from New York to Florida on April 1, where there is a pending service request for a flight from Florida to Phoenix on April 3. As such, the system is not limited to matching dual one-legs, and may match (and discount fares for) two or more one-legs to facilitate optimal equipment utilization/revenue generation.

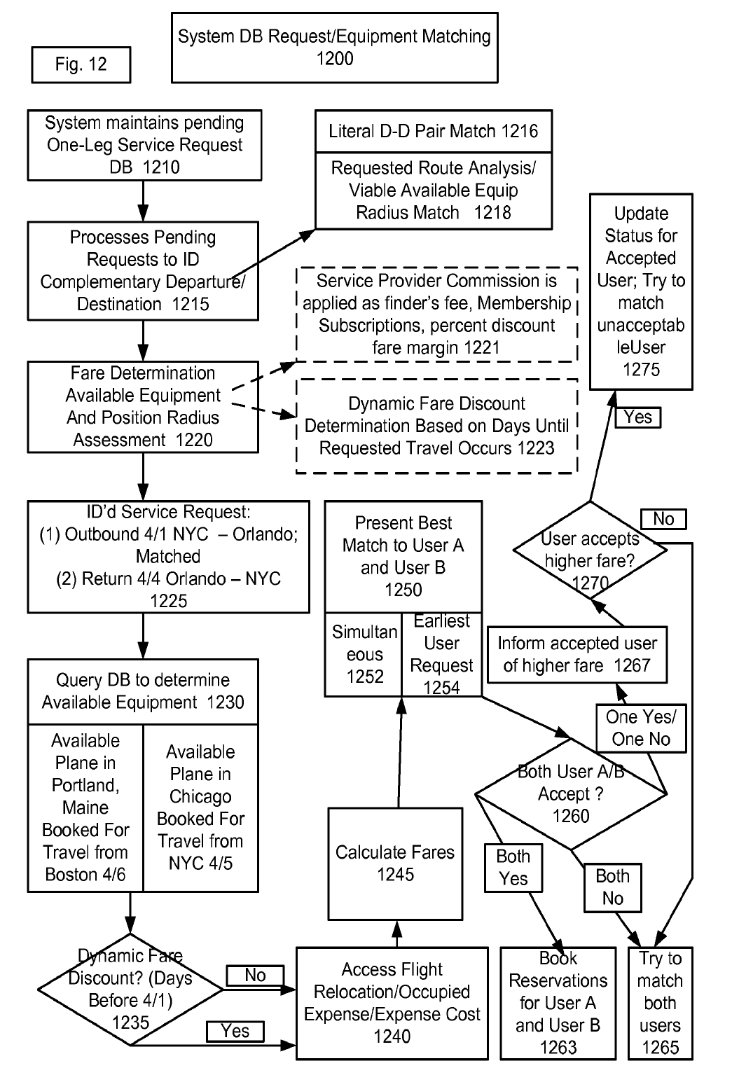

FIG. 12 illustrates aspects of another implementation of a system database service request and equipment matching. The system manages pending one-leg service requests in a database 1210 and processes new service requests in order to identify complementary departure/destination one-leg requests 1215. For example, a literal departure/destination matching may be identified 1216, if a user service request asks for an outbound flight from NYC to Orlando on April 1st. A complementary matching service request may be for an outbound flight from Orlando to NYC on April 4th. To identify the best system match, the system may also perform an analysis of the requested route 1218 in order to identify if there is viable available equipment within a certain defined radius. For example, a system match may be identified if there is an outbound flight from NYC to Orlando on April 1st and an outbound flight from Orlando to Newark on April 4th.

Once the complementary departure/destination pair has been identified, the system may determine the trip fare(s) based on the available equipment and an assessment of the re-positioning radius 1220. The trip fare(s) may include a service provider commission which can be applied as a finder's fee, membership subscriptions, percentage discount fare margin 1221, and/or the like. The system may also use a dynamic fare discount determination mechanism (i.e., such as the one described in the context of FIG. 11) based on the number of days until the requested travel date 1223. Also, as part of determining the best match/fare for a particular service request, the system may query an equipment availability database to determine if there is equipment available to perform the two matched legs of the trip. In the described example where the system identified match is (1) outbound flight from NYC to Orlando on April 1st with (2) an outbound flight from Orlando to NYC on April 4th the fare may vary depending on equipment availability 1225.

The system may analyze available equipment and determine the best match for available aircraft 1230. For example, the system may balance the re-positioning expenses of bringing a plane to New York from Portland, Maine for the outbound 4/1 flight, which is ultimately booked from travel from Boston April 6 with bringing a second aircraft in from Chicago (a little further away) to conduct the outbound flight if the second aircraft is booked to conduct a flight back out of New York on April 5. Once potentially available equipment is identified, a dynamic fare discount policy may be implemented 1235 in order to calculate the fares by first considering access flight re-location expenses, occupied flight expenses, unoccupied flight expenses, days until the requested travel date and a number of other expense cost parameters 1240.

In one implementation, once the fares have been calculated 1245, both users A and B may be presented with an offer with the availability and pricing information simultaneously and given a specified amount of time in which to make a decision 1252. In another implementation, the user who submitted the earliest request is contacted first with the availability and pricing information in order to ensure that his request is still pending 1254. If both requests are still pending and both users A and B accept the offer 1260, the system reserves the trip for both users 1263. If, however, only one of the users accepts the offer, the system may inform the accepting user of the higher fare due to the rejection of the offer by the other user 1267. If the user accepts the new higher offer 1270, the system reserves the trip for that user and continues to find a matching trip for the user who has not accepted the offer 1275. Alternatively, if the user does not accept the new higher offer, the system continues to try and match the users requests with other currently pending requests or with requests received in the future 1265. Finally, if both users reject the initial offers 1260, the system also continues to try and match the users' requests with other currently pending requests or with requests received in the future 1265.

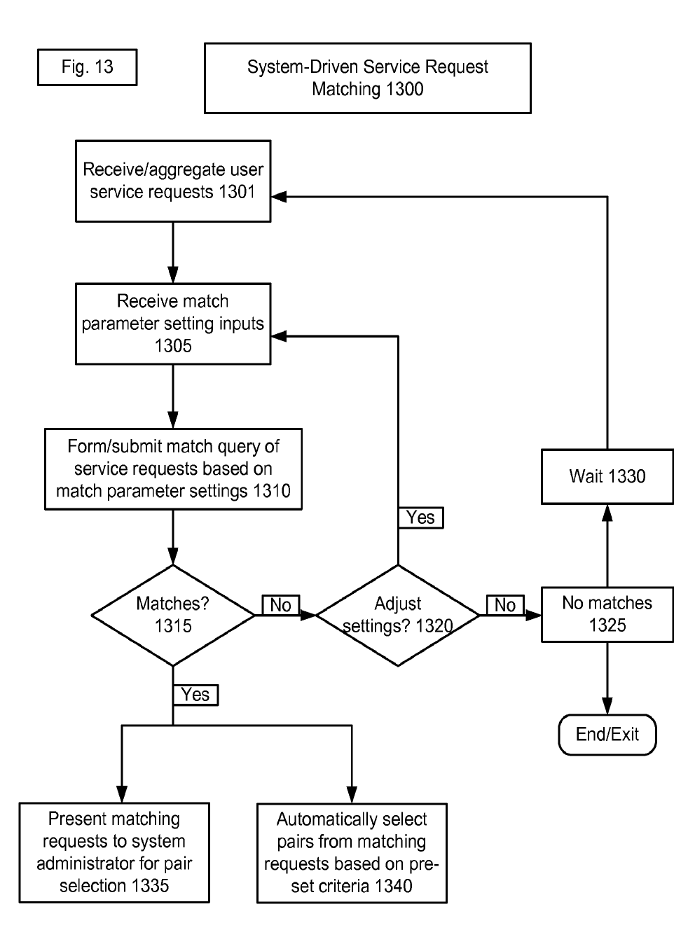

FIG. 13 illustrates aspects of system-driven service request matching in one implementation 1300. A plurality of service requests, such as may take the form of emails, structured entries to a web form, and/or the like, are received and/or aggregated, stored in a database, and/or the like 1301. The system may also receive match parameter setting inputs 1305, which may define and/or limit the criteria based on which matches between service requests may be discerned and/or determined by the system. Examples of match parameters that may be set may include the threshold value for the combined time of a first and second user's trips; the relative distance between destination/departure locations of a first and second user's travel itineraries; the separation between destination/departure times/dates of a first and second user's travel itineraries; user subscription statuses (e.g., limiting matches to premium subscriptions, and/or the like); and/or the like match criteria. The system may then form and/or submit a query seeking matching service requests from all aggregated service requests, the query being consistent with the input match parameter settings 1310. A determination is made at 1315 as to whether any matching service requests can be discerned. If not, a second determination may be made as to whether adjustments are to be made to the match parameter settings 1320. If so, the system may return to 1305, again provide a match parameter setting input interface, and/or the like. If adjustments to the match parameter settings are not warranted, the system establishes that no matches have been found 1325, such as by providing a message to a system administrator, storing a record of the unsuccessful matching in a log or database, and/or the like. The system may then end and/or exit from the current round of system-driven service request matching. In an alternative implementation, the system may wait for a period of time 1330 and receive further service requests 1301 before again seeking matching requests. If matches are discerned at 1315, the system may, in one implementation, present a listing of matching service requests to a system administrator for pair selection 1335. The administrator may, for example, indicate which matched pairs of service requests he or she deems acceptable, desirable, and/or the like by selecting those pairs via a graphical user interface, causing the system to assign a special status to the selected pairs. In an alternative implementation, the system may automatically rank and/or select matching request pairs from the set of all matched requests based on pre-set criteria 1340. Whether matched request pairs are selected by a system administrator or automatically by the system, those pairs may be assigned a special status and/or have further processing performed. For example, users associated with selected match pairs may be notified of the possible match and provided the opportunity to accept or decline an offer to take advantage of the matched itineraries, receive discounts, and/or the like.

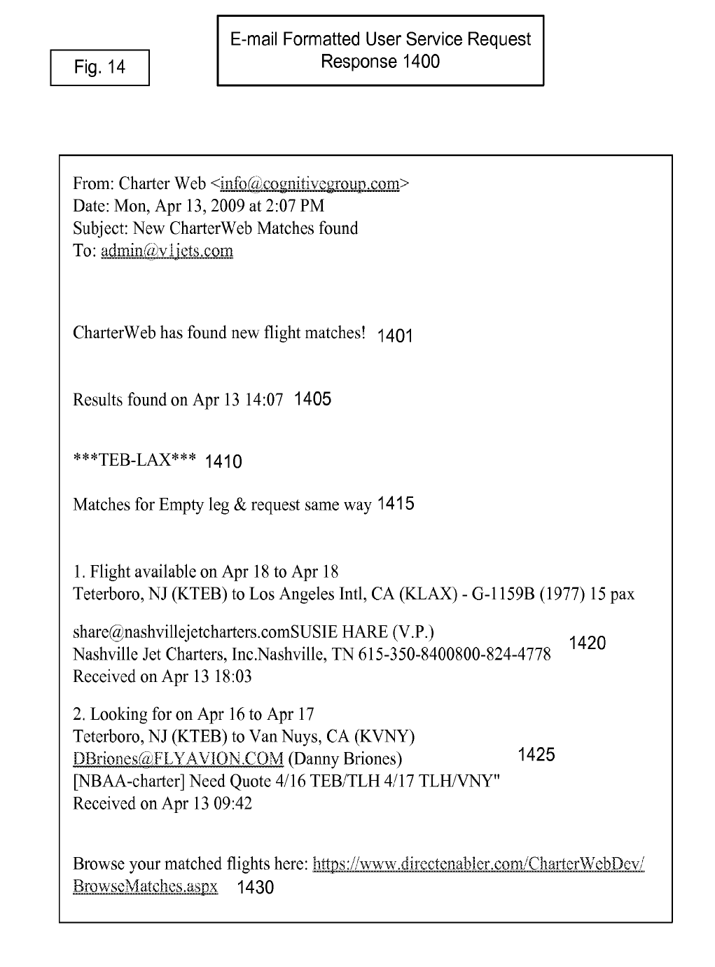

FIG. 14 illustrates aspects of e-mail formatted user service request response in one implementation 1400. A user submitting a service request query may, in one implementation, receive an e-mail response containing search results matching the user's travel specifications. In the illustrated implementation, a message 1401 is included indicating that matches to the service request have been identified. The message further includes an indication of when the results were identified 1405 and the departure and arrival designations 1410. In the illustrated implementation, the message includes an indication 1415 that match results for both empty legs and other user requests are shown in the same result set. Thus, an available flight is indicated as the first result in the list 1420, while the second result in the list 1425 is a record associated with a user seeking the same or a similar flight as the user receiving the e-mail. The system may also be configured to provide records of users looking for flights in the opposite direction from the user receiving the e-mail, thereby effectuating DOCF, filling of unoccupied return legs, optimizing equipment allocation, and/or the like. The e-mail also may include a link 1430 to browse more information about matched flights.

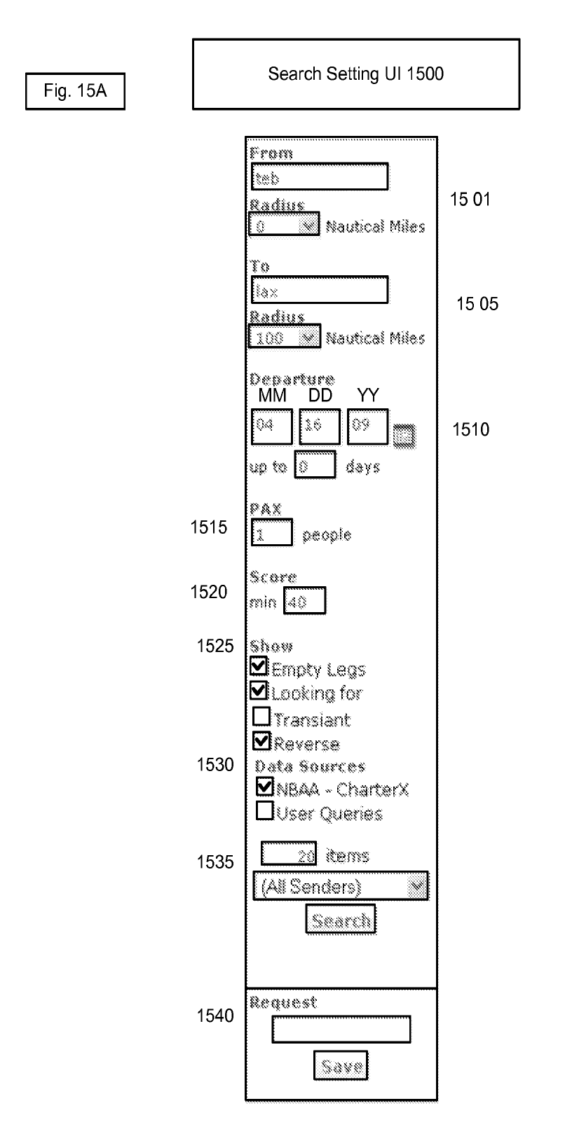

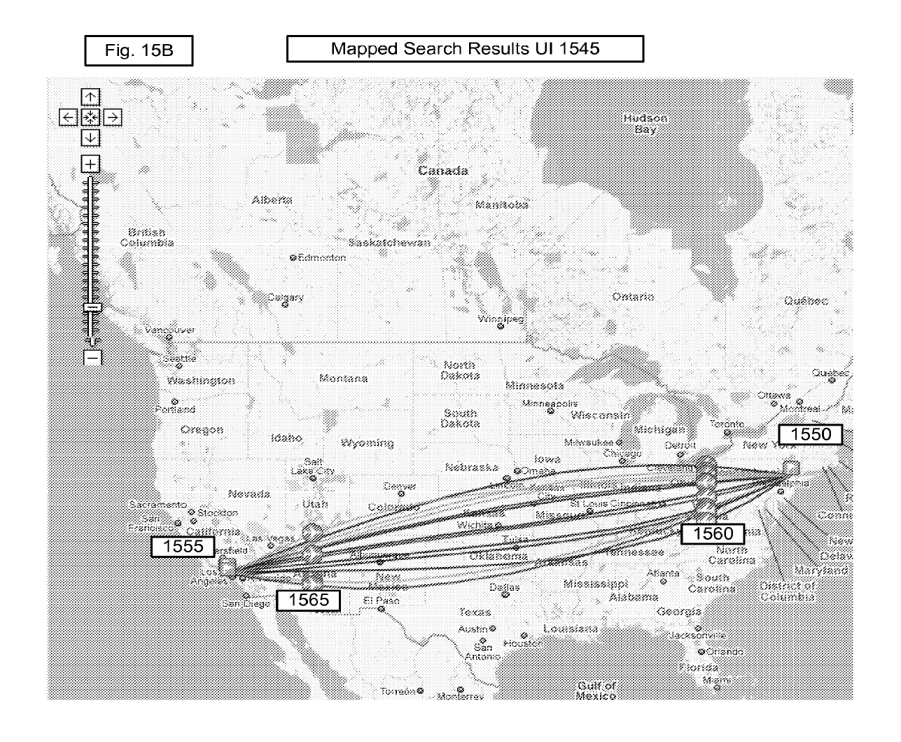

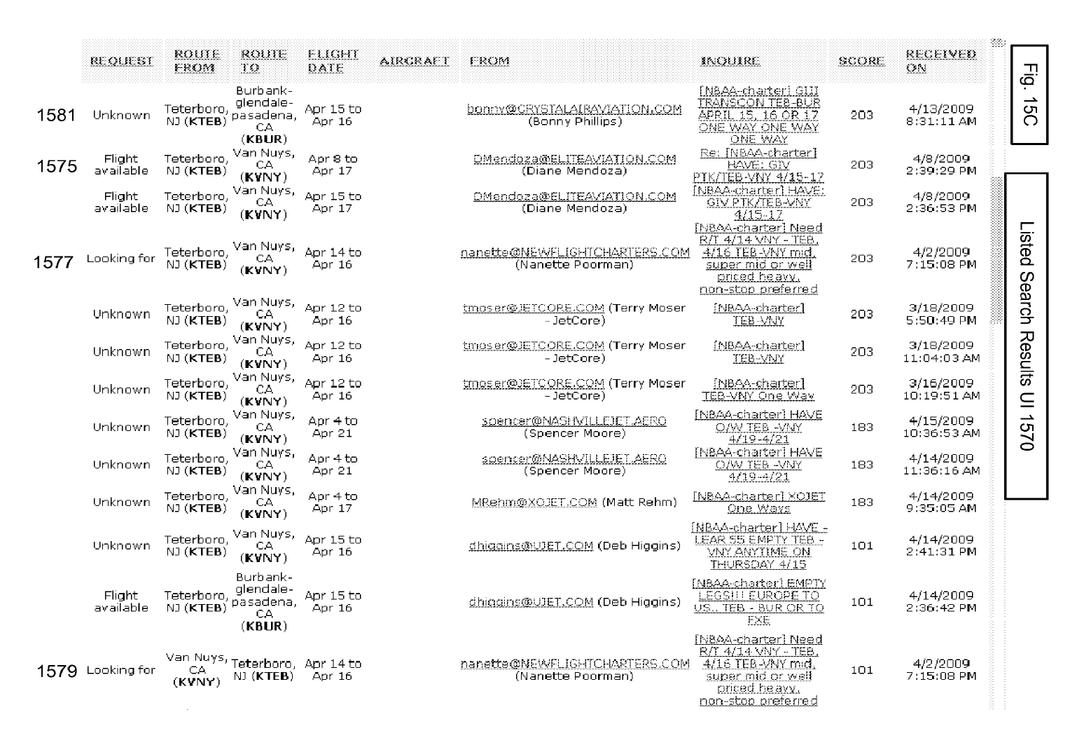

FIGS. 15A-15C show aspects of an implementation of user interfaces in one embodiment. FIG. 15A shows aspects of a search setting UI 1500, by which a system user, administrator, and/or the like may submit a search query, adjust search settings, and/or the like. The UI 1500 includes fields to set a departure location 1501 and destination location 1505, as well as acceptable distances therefrom for each. A field is shown at 1515 for specifying the number of people for which a flight is requested. At 1520, the user may set a minimum match score, such that charter flights having a lower score will not be included in the returned results. The check boxes at 1525 allow the user to specify what types of results to return. In this case, the user has selected search results that are any combination of empty legs, other users looking for matching legs, and reverse legs. Thus, for example, a user looking for the reverse trip of the one specified at 1501 and 1505 will be shown in the returned results if any exist. The user may also specify data sources to be used for the query 1530, as well as the number of results to return 1535. The user may also be permitted to specify a name for and save the request via the text box and save button at 1540.

FIG. 15B shows aspects of a mapped search results UI in one implementation 1545. The map shown includes the departure 1550 and destination 1555 locations, and graphical representations of various flights corresponding to search results retrieved in response to the user query. Because the settings in 1500 were set to include reverse results, both flights in the same direction as the request 1560 as well as those in the opposite direction 1565 are included in the results. The trajectories of different flights may be further adjusted to reflect characteristics of the search result. For example, the flight trajectories may be color coded, hashed, dashed, broken, dotted, and/or the like to indicate a variety of factors, such as the match score, likely availability, whether the flight is available or requested by another user, and/or the like.

FIG. 15C shows aspects of a listed search results UI in one implementation 1570. In contrast to 1545 where the search results were shown as flight trajectories on a map, here the results are shown as a list of information, including the type of result, the route from, the route to, the flight date, the type of aircraft, the user originally providing the result, a link to inquire about the result and/or receive more information, the match score, and the date the result was received. Results having different characteristics may, in one implementation, be shown on a similar footing. For example, the displayed results in FIG. 15C include an available flight in the direction of the request 1575, a requested flight in the direction of the request 1577, a requested flight in the opposite direction of the request 1577, and a result in the direction of the request of unknown status 1581.

As such, the system facilitates significant flexibility and may be configured to implement a wide variety of one-leg matching margin/revenue goals. Furthermore, the matched one-legs may also significantly increase equipment utilization rates, as well as system user loyalty and/or registered user subscription rates. The system facilitates service providers with the flexibility to charge system administration fees/expenses to the charter service providers and/or service requesting users as part of providing discounted fares/services.

### Travel Aggregation System (TAS) Controller

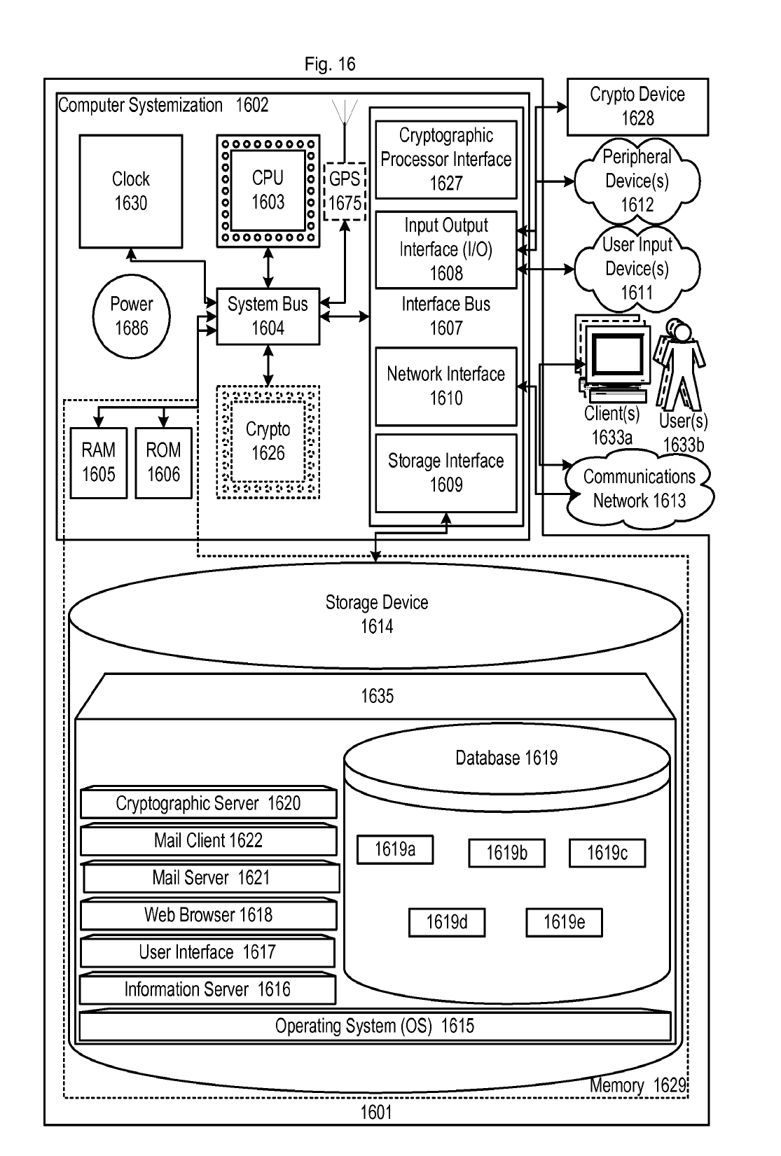

The travel aggregation system described above may be embodied by a travel aggregation system (TAS) controller 1601. FIG. 16 of the present disclosure illustrates inventive aspects of the TAS controller 1601 in a block diagram. In this embodiment, the TAS controller 1601 may serve to obtain/receive, process charter data objects, create charter data records, and facilitate charter data record management and search functionality.

Computers employ processors to process information; such processors are often referred to as central processing units (CPU). A common form of processor is referred to as a microprocessor. A computer operating system, which, typically, is software executed by CPU on a computer, enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through database software. Information technology systems provide interfaces that allow users to access and operate various system components.

In one embodiment, the TAS controller 1601 may be connected to and/or communicate with entities such as, but not limited to: one or more users from user input devices 1611; peripheral devices 1612; a cryptographic processor device 1628; and/or a communications network 1613.

Networks are commonly thought to comprise the interconnection and interoperation of clients, servers, and intermediary nodes in a graph topology. It should be noted that the term “server” as used throughout this disclosure refers generally to a computer, other device, software, or combination thereof that processes and responds to the requests of remote users across a communications network. Servers serve their information to requesting “clients.” The term “client” as used herein refers generally to a computer, other device, software, or combination thereof that is capable of processing and making requests and obtaining and processing any responses from servers across a communications network. A computer, other device, software, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The TAS controller 1601 may be based on computer systems that may comprise, but are not limited to, components such as: a computer systemization 1602 connected to memory 1629.

### Computer Systemization

A computer systemization 1602 may comprise a clock 1630, central processing unit (CPU) 1603, a read only memory (ROM) 1606, a random access memory (RAM) 1605, and/or an interface bus 1607, and most frequently, although not necessarily, are all interconnected and/or communicating through a system bus 1604. Optionally, the computer systemization may be connected to an internal power source 1686. Optionally, a cryptographic processor 1626 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program modules for executing user and/or system-generated requests. The CPU may be a microprocessor such as AMD's Athlon, Duron and/or Opteron; IBM and/or Motorola's PowerPC; Intel's Celeron, Itanium, Pentium, Xeon, and/or XScale; and/or the like processor(s). The CPU interacts with memory through signal passing through conductive conduits to execute stored program code according to conventional data processing techniques. Such signal passing facilitates communication within the TAS controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

### Power Source

The power source 1686 may be of any standard form for powering small electronic circuit board devices such as the following power cells: alkaline, lithium hydride, lithium ion, nickel cadmium, solar cells, and/or the like. Other types of AC or DC power sources may be used as well. In the case of solar cells, in one embodiment, the case provides an aperture through which the solar cell may capture photonic energy. The power cell 1686 is connected to at least one of the interconnected subsequent components of the TAS thereby providing an electric current to all subsequent components. In one example, the power source 1686 is connected to the system bus component 1604. In an alternative embodiment, an outside power source 1686 is provided through a connection across the I/O 1608 interface. For example, a USB and/or IEEE 1694 connection carries both data and power across the connection and is therefore a suitable source of power.

### Interface Adapters

Interface bus(ses) 1607 may accept, connect, and/or communicate to a number of interface adapters, conventionally although not necessarily in the form of adapter cards, such as but not limited to: input output interfaces (I/O) 1608, storage interfaces 1609, network interfaces 1610, and/or the like. Optionally, cryptographic processor interfaces 1627 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1609 may accept, communicate, and/or connect to a number of storage devices such as, but not limited to: storage devices 1614, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1610 may accept, communicate, and/or connect to a communications network 1613. Through a communications network 1613, the TAS controller is accessible through remote clients 1633a (e.g., computers with web browsers) by users 1633b. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1610 may be used to engage with various communications network types 1613. For example, multiple network interfaces may be employed to allow for the communication over broadcast, multicast, and/or unicast networks.

Input Output interfaces (I/O) 1608 may accept, communicate, and/or connect to user input devices 1611, peripheral devices 1612, cryptographic processor devices 1628, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 1611 may be card readers, dongles, finger print readers, gloves, graphics tablets, joysticks, keyboards, mouse (mice), remote controls, retina readers, trackballs, trackpads, and/or the like.

Peripheral devices 1612 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the TAS controller may be embodied as an embedded, dedicated, and/or monitor-less (i.e., headless) device, wherein access would be provided over a network interface connection.

Cryptographic units such as, but not limited to, microcontrollers, processors 1626, interfaces 1627, and/or devices 1628 may be attached, and/or communicate with the TAS controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 740 MHz Roadrunner.

### Memory

Generally, any mechanization and/or embodiment allowing a processor to affect the storage and/or retrieval of information is regarded as memory 1629. However, memory is a fungible technology and resource, thus, any number of memory embodiments may be employed in lieu of or in concert with one another. It is to be understood that the TAS controller and/or a computer systemization may employ various forms of memory 1629. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 1629 will include ROM 06, RAM 05, and a storage device 1614. A storage device 1614 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); and/or other devices of the like. Thus, a computer systemization generally requires and makes use of memory.

### Module Collection

The memory 1629 may contain a collection of program and/or database modules and/or data such as, but not limited to: operating system module(s) 1615 (operating system); information server module(s) 1616 (information server); user interface module(s) 1617 (user interface); Web browser module(s) 1618 (Web browser); database(s) 1619; cryptographic server module(s) 1620 (cryptographic server); the TAS module(s) 1635; and/or the like (i.e., collectively a module collection). These modules may be stored and accessed from the storage devices and/or from storage devices accessible through an interface bus. Although non-conventional software modules such as those in the module collection, typically, are stored in a local storage device 1614, they may also be loaded and/or stored in memory such as: peripheral devices, RAM, remote storage facilities through a communications network, ROM, various forms of memory, and/or the like.

### Operating System

The operating system module 1615 is executable program code facilitating the operation of the TAS controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, Windows Server 2000/2003 and/or the like operating systems. However, more limited and/or less secure operating systems also may be employed such as Apple Macintosh OS, Microsoft DOS, Palm OS, Windows 2000/3.1/95/98/CE/Millenium/NT/XP/Vista and/or the like. An operating system may communicate to and/or with other modules in a module collection, including itself, and/or the like. Most frequently, the operating system communicates with other program modules, user interfaces, and/or the like. For example, the operating system may contain, communicate, generate, obtain, and/or provide program module, system, user, and/or data communications, requests, and/or responses. The operating system, once executed by the CPU, may enable the interaction with communications networks, data, I/O, peripheral devices, program modules, memory, user input devices, and/or the like. The operating system may provide communications protocols that allow the TAS controller to communicate with other entities through a communications network 1613. Various communication protocols may be used by the TAS controller as a subcarrier transport mechanism for interaction, such as, but not limited to: multicast, TCP/IP, UDP, unicast, and/or the like.

### Information Server

An information server module 1616 is stored program code that is executed by the CPU. The information server may be a conventional Internet information server such as, but not limited to Apache Software Foundation's Apache, Microsoft's Internet Information Server, and/or the. The information server may allow for the execution of program modules through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program modules. After a Domain Name System (DNS) resolution portion of an HTTP request is resolved to a particular information server, the information server resolves requests for information at specified locations on the TAS controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html” Additionally, other information serving protocols may be employed across various ports, e.g., FTP communications across port 721, and/or the like. An information server may communicate to and/or with other modules in a module collection, including itself, and/or facilities of the like. Most frequently, the information server communicates with the TAS database 1619, operating systems, other program modules, user interfaces, Web browsers, and/or the like.

Access to the TAS database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the TAS. In one embodiment, the information server would provide a Web form accessible by a Web browser. Entries made into supplied fields in the Web form are tagged as having been entered into the particular fields, and parsed as such. The entered ten's are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the TAS as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program module, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface module 1617 is stored program code that is executed by the CPU. The user interface may be a conventional graphic user interface as provided by, with, and/or atop operating systems and/or operating environments such as Apple Macintosh OS, e.g., Aqua, Microsoft Windows (NT/XP), Unix X Windows (KDE, Gnome, and/or the like), mythTV, and/or the like. The user interface may allow for the display, execution, interaction, manipulation, and/or operation of program modules and/or system facilities through textual and/or graphical facilities. The user interface provides a facility through which users may affect, interact, and/or operate a computer system. A user interface may communicate to and/or with other modules in a module collection, including itself, and/or facilities of the like. Most frequently, the user interface communicates with operating systems, other program modules, and/or the like. The user interface may contain, communicate, generate, obtain, and/or provide program module, system, user, and/or data communications, requests, and/or responses.

### Web Browser

A Web browser module 1618 is stored program code that is executed by the CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program modules through facilities such as Java, JavaScript, ActiveX, and/or the like. Web browsers and like information access tools may be integrated into PDAs, cellular telephones, and/or other mobile devices. A Web browser may communicate to and/or with other modules in a module collection, including itself, and/or facilities of the like. Most frequently, the Web browser communicates with information servers, operating systems, integrated program modules (e.g., plug-ins), and/or the like; e.g., it may contain, communicate, generate, obtain, and/or provide program module, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the TAS enabled nodes. The combined application may be nugatory on systems employing standard Web browsers.

### Cryptographic Server

A cryptographic server module 1620 is stored program code that is executed by the CPU 1603, cryptographic processor 1626, cryptographic processor interface 1627, cryptographic processor device 1628, and/or the like. Cryptographic processor interfaces will allow for expedition of encryption and/or decryption requests by the cryptographic module; however, the cryptographic module, alternatively, may run on a conventional CPU. The cryptographic module allows for the encryption and/or decryption of provided data. The cryptographic module allows for both symmetric and asymmetric (e.g., Pretty Good Protection (PGP)) encryption and/or decryption. The cryptographic module may employ cryptographic techniques such as, but not limited to: digital certificates (e.g., X.509 authentication framework), digital signatures, dual signatures, enveloping, password access protection, public key management, and/or the like. The cryptographic module will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the TAS controller may encrypt all incoming and/or outgoing communications and may serve as node within a virtual private network (VPN) with a wider communications network. The cryptographic module facilitates the process of “security authorization” whereby access to a resource is inhibited by a security protocol wherein the cryptographic module effects authorized access to the secured resource. In addition, the cryptographic module may provide unique identifiers of content, e.g., employing and MD5 hash to obtain a unique signature for an digital audio file. A cryptographic module may communicate to and/or with other modules in a module collection, including itself, and/or facilities of the like. The cryptographic module supports encryption schemes allowing for the secure transmission of information across a communications network to enable the TAS module to engage in secure transactions if so desired. The cryptographic module facilitates the secure accessing of resources on the TAS and facilitates the access of secured resources on remote systems; i.e., it may act as a client and/or server of secured resources. Most frequently, the cryptographic module communicates with information servers, operating systems, other program modules, and/or the like. The cryptographic module may contain, communicate, generate, obtain, and/or provide program module, system, user, and/or data communications, requests, and/or responses.

### The TAS Database

The TAS database module 1619 may be embodied in a database and its stored data. The database is stored program code, which is executed by the CPU; the stored program code portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the TAS database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the TAS database is implemented as a data-structure, the use of the TAS database 1619 may be integrated into another module such as the TAS module 1635. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database module 1619 includes several tables 1619a-e. A charter data object source table 1619a includes fields such as, but not limited to: source ID, preferred formatting information, corresponding parsing rules, carrier information, user satisfaction, and/or the like. A charter data extraction tool set table 1619b includes fields such as, but not limited to: parsing priority, charter indicator information, charter characteristic information, scoring rule sets, and/or the like. A charter data record table 1619c includes fields such as, but not limited to: source ID, departure and/or destination locations, available equipment, time availability, and/or the like. A dynamic search update table 1619d includes fields such as, but not limited to: user ID, request ID, best match search result, update frequency data, initial search request parameters, alternate search result parameters, and/or the like. A pending one-leg reservation table 1619e includes fields such as, but not limited to: user ID, request ID, pending one-leg match, initial search request parameters, and/or the like.

In one embodiment, the TAS database may interact with other database systems. For example, employing a distributed database system, queries and data access by the TAS modules may treat the combination of the TAS and TAS database as a single database entity.

In one embodiment, user programs may contain various user interface primitives, which may serve to update the TAS. Also, various accounts may require custom database tables depending upon the environments and the types of clients the TAS may need to serve. It should be noted that any unique fields may be designated as a key field throughout. In an alternative embodiment, these tables have been decentralized into their own databases and their respective database controllers (i.e., individual database controllers for each of the above tables). Employing data processing techniques, one may further distribute the databases over several computer systemizations and/or storage devices. Similarly, configurations of the decentralized database controllers may be varied by consolidating and/or distributing the various database modules 1619a-e. The TAS may be configured to keep track of various settings, inputs, and parameters via database controllers.

The TAS database may communicate to and/or with other modules in a module collection, including itself, and/or facilities of the like. Most frequently, the TAS database communicates with the TAS module, other program modules, and/or the like. The database may contain, retain, and provide information regarding other nodes and data.

### The TAS Control Module

The TAS module 1635 is stored program code that is executed by the CPU. The TAS control module affects accessing, obtaining and the provision of information, services, transactions, and/or the like across various communications networks.

The TAS module enables access of information between nodes and may be developed by employing standard development tools such as, but not limited to: (ANSI) (Objective-) C (++), Apache modules, binary executables, database adapters, Java, JavaScript, mapping tools, procedural and object oriented development tools, PERL, Python, shell scrip ts, SQL commands, web application server extensions, WebObjects, and/or the like. In one embodiment, the TAS server employs a cryptographic server to encrypt and decrypt communications. The TAS module may communicate to and/or with other modules in a module collection, including itself, and/or facilities of the like. Most frequently, the TAS module communicates with the TAS database, operating systems, other program modules, and/or the like. The TAS may contain, communicate, generate, obtain, and/or provide program module, system, user, and/or data communications, requests, and/or responses.

### Distributed TAS

The structure and/or operation of any of the TAS node controller components may be combined, consolidated, and/or distributed in any number of ways to facilitate development and/or deployment. Similarly, the module collection may be combined in any number of ways to facilitate deployment and/or development. To accomplish this, one may integrate the components into a common code base or in a facility that can dynamically load the components on demand in an integrated fashion.

The module collection may be consolidated and/or distributed in countless variations through standard data processing and/or development techniques. Multiple instances of any one of the program modules in the program module collection may be instantiated on a single node, and/or across numerous nodes to improve performance through load-balancing and/or data-processing techniques. Furthermore, single instances may also be distributed across multiple controllers and/or storage devices; e.g., databases. All program module instances and controllers working in concert may do so through standard data processing communication techniques.

The configuration of the TAS controller will depend on the context of system deployment. Factors such as, but not limited to, the budget, capacity, location, and/or use of the underlying hardware resources may affect deployment requirements and configuration. Regardless of if the configuration results in more consolidated and/or integrated program modules, results in a more distributed series of program modules, and/or results in some combination between a consolidated and distributed configuration, data may be communicated, obtained, and/or provided. Instances of modules consolidated into a common code base from the program module collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If module collection components are discrete, separate, and/or external to one another, then communicating, obtaining, and/or providing data with and/or to other module components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete module components for inter-application communication or within memory spaces of a singular module for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between modules. Again, the configuration will depend upon the context of system deployment.

Among the embodiments envisioned as being within the scope of the present apparatuses, methods and systems are the following:

1. A computer-implemented method embodiment for managing processed charter data comprising:
receiving a first charter data search request;
identifying a charter indicator within the first charter data search request;
processing the first charter data search request to derive charter location, time and equipment request information;
correlating the processed request information of the first charter data search request to available charter data from a flight data record as initial search results; and
displaying a best match result to the first charter data search request and alternates to the best match.

2. The method of embodiment 1, further comprising:
receiving a selection of one of the displayed search results; and
storing the selection as a pending one-leg service request.

3. The method of embodiment 2, further comprising:
receiving a second charter data search request;
identifying a charter indicator within the second charter data search request;
processing the second charter data search request to derive charter location, time and equipment request information;
determining if the processed request information of the second charter data search request is complementary to a pending one-leg service request;
if the processed request information of the second charter data search request is complementary to a pending one-leg service request, identifying the two charter data search requests as a best match dual one-leg charter facilitation pair and displaying the updated matching results;
if the processed request information of the second charter data search request is not complementary to a pending one-leg service request:
   correlating the processed request information to available charter data from a flight data record as initial search results;
   displaying a best match result to the second charter data search request and alternates to the best match;
   receiving a selection of one of the displayed search results; and
   storing the selection as a pending one-leg service request.

4. The method of embodiment 3, wherein the first and second charter data search requests are configured as visual-based charter data search requests.

5. The method of embodiment 3, wherein the first and second charter data search requests are configured as textual based charter data search request.

6. The method of embodiment 5, wherein the textual based charter data search request is a non-structured request document.

7. The method of embodiment 6, wherein the non-structured request document is configured as an email.

8. The method of embodiment 3, wherein the determination process includes identifying alternates to the best match dual one-leg charter facilitation pair based on available equipment.

9. The method of embodiment 3, wherein the determination process includes identifying alternates to the best match dual one-leg charter facilitation pair based on available destination or departure times.

10. The method of embodiment 3, wherein the determination process includes identifying alternates to the best match dual one-leg charter facilitation pair based on available destination or departure location.

11. The method of embodiment 3, wherein the determination process includes identifying alternates to the best match dual one-leg charter facilitation pair based on equipment that may be relocated to create improved match results.

12. The method of embodiment 3, wherein if the processed request information of the second charter data search request is not complementary to a pending one-leg service request, the correlation process includes identifying alternates for the identified best match based on available equipment.

13. The method of embodiment 3, wherein if the processed request information of the second charter data search request is not complementary to a pending one-leg service request, the correlation process includes identifying alternates for the identified best match based on available destination or departure times.

14. The method of embodiment 3, wherein if the processed request information of the second charter data search request is not complementary to a pending one-leg service request, the correlation process includes identifying alternates for the identified best match based on available destination or departure location.

15. The method of embodiment 3, wherein if the processed request information of the second charter data search request is not complementary to a pending one-leg service request, the correlation process includes identifying alternates for the identified best match based on equipment that may be relocated to create improved match results.

16. The method of embodiment 3, wherein identifying the two charter data search requests as a best match dual one-leg charter facilitation pair and displaying the updated matching results includes determining fare information for both matched charter data search requests.

17. The method of embodiment 16, wherein determining fare information includes determining fare discounts that depend on the number of days remaining until the departure date of the complementary pending one-leg service request.

18. A system embodiment for managing processed charter data comprising:
a memory in communication with the processor and containing program instructions;
an input and output in communication with the processor and memory;
wherein the processor executes program instructions contained in the memory and the program instructions comprise:
   receiving a first charter data search request;
   identifying a charter indicator within the first charter data search request;
   processing the first charter data search request to derive charter location, time and equipment request information;
   correlating the processed request information of the first charter data search request to available charter data from a flight data record as initial search results; and
   displaying a best match result to the first charter data search request and alternates to the best match.

19. The system of embodiment 18, wherein the processor also executes program instructions for:
receiving a selection of one of the displayed search results; and
storing the selection as a pending one-leg service request.

20. The system of embodiment 19, wherein the processor also executes program instructions for:
receiving a second charter data search request;
identifying a charter indicator within the second charter data search request;
processing the second charter data search request to derive charter location, time and equipment request information;
determining if the processed request information of the second charter data search request is complementary to a pending one-leg service request;
if the processed request information of the second charter data search request is complementary to a pending one-leg service request, identifying the two charter data search requests as a best match dual one-leg charter facilitation pair and displaying the updated matching results;
if the processed request information of the second charter data search request is not complementary to a pending one-leg service request:
   correlating the processed request information to available charter data from a flight data record as initial search results;
   displaying a best match result to the second charter data search request and alternates to the best match;
   receiving a selection of one of the displayed search results; and
   storing the selection as a pending one-leg service request.

21. The system of embodiment 19, wherein the first and second charter data search requests are configured as visual-based charter data search requests.

22. The system of embodiment 19, wherein the first and second charter data search requests are configured as textual based charter data search request.

23. The system of embodiment 22, wherein the textual based charter data search request is a non-structured request document.

24. The system of embodiment 23, wherein the non-structured request document is configured as an email.

25. The system of embodiment 20, wherein the determination process includes identifying alternates to the best match dual one-leg charter facilitation pair based on available equipment.

26. The system of embodiment 20, wherein the determination process includes identifying alternates to the best match dual one-leg charter facilitation pair based on available destination or departure times.

27. The system of embodiment 20, wherein the determination process includes identifying alternates to the best match dual one-leg charter facilitation pair based on available destination or departure location.

28. The system of embodiment 20, wherein the determination process includes identifying alternates to the best match dual one-leg charter facilitation pair based on equipment that may be relocated to create improved match results.

29. The system of embodiment 20, wherein if the processed request information of the second charter data search request is not complementary to a pending one-leg service request, the correlation process includes identifying alternates for the identified best match based on available equipment.

30. The system of embodiment 20, wherein if the processed request information of the second charter data search request is not complementary to a pending one-leg service request, the correlation process includes identifying alternates for the identified best match based on available destination or departure times.

31. The system of embodiment 20, wherein if the processed request information of the second charter data search request is not complementary to a pending one-leg service request, the correlation process includes identifying alternates for the identified best match based on available destination or departure location.

32. The system of embodiment 20, wherein if the processed request information of the second charter data search request is not complementary to a pending one-leg service request, the correlation process includes identifying alternates for the identified best match based on equipment that may be relocated to create improved match results.

33. The system of embodiment 20, wherein identifying the two charter data search requests as a best match dual one-leg charter facilitation pair and displaying the updated matching results includes determining fare information for both matched charter data search requests.

34. The method of embodiment 33, wherein determining fare information includes determining fare discounts that depend on the number of days remaining until the departure date of the complementary pending one-leg service request.

35. A processor-implemented method embodiment to facilitate matching of travel service requests, comprising:
receiving a first travel service request comprising first travel information including at least a first departure location, first arrival location, and first time of travel;
receiving a second travel service request comprising second travel information including at least a second departure location, second arrival location, and a second time of travel;
determining a correlation between the first travel service request and the second travel service request based on the first travel information and the second travel information; and
storing a paired relationship between the first travel service request and the second travel service request in a database if the correlation meets correlation threshold criteria.

36. The method of embodiment 35, wherein determining a correlation further comprises:
comparing the first arrival location and the second departure location to derive a first location comparison; and
determining the correlation between the first travel service request and the second travel service request based on the first location comparison, the first time of travel, and the second time of travel.

37. The method of embodiment 36, wherein the correlation meets the correlation threshold criteria only if the first location comparison indicates that a distance between the first arrival location and the second departure location is less than a first threshold distance.

38. The method of embodiment 37, wherein determining a correlation further comprises:
comparing the first departure location and the second arrival location to derive a second location comparison; and
determining the correlation between the first travel service request and the second travel service request further based on the second location comparison, wherein the correlation meets the correlation threshold criteria only if the second location comparison indicates that a distance between the first departure location and the second arrival location is less than a second threshold distance.

39. The method of embodiment 35, wherein the first time of travel includes at least a first arrival date and the second time of travel includes at least a second departure date, and wherein determining a correlation further comprises:
comparing the first arrival date and second departure date to derive a first time comparison; and
wherein the correlation meets the correlation threshold criteria only if the first time comparison is less than a first threshold time.

40. The method of embodiment 35, wherein determining a correlation further comprises:
retrieving the first travel information from a database based on analysis of the second travel information;
providing the first travel information for display to a second travel service request user submitting the second travel service request;
receiving a selection associated with the first travel information from the second travel service request user;
wherein the correlation meets correlation threshold criteria only if the selection associated with the first travel information is received.

41. The method of embodiment 40, wherein retrieving the first travel information from a database based on analysis of the second travel information further comprises:
comparing the first arrival location to the second departure location to derive a first location comparison;
comparing the first time of travel to the second time of travel to derive a first time comparison; and
wherein the first travel information is only retrieved if the first location comparison is less than a first distance threshold and the first time comparison is less than a first time threshold.

42. The method of embodiment 41, wherein the first location comparison comprises a distance between the first arrival location and the second departure location.

43. The method of embodiment 41, wherein the first time comparison comprises a difference between a first arrival time associated with the first time of travel and a second departure time associated with the second time of travel.

44. The method of embodiment 35, wherein determining a correlation further comprises:
providing the first and second travel service requests for display to a system administrator;
receiving a pair selection of the first and second travel service requests from the system administrator;
wherein the correlation meets the correlation threshold criteria only if the pair selection of the initially matched first and second travel service requests is received.

45. The method of embodiment 44, wherein providing the initially matched first and second travel service requests occur in response to a search request.

46. The method of embodiment 45, wherein the search request comprises at least a departure location, an arrival location, a travel date, and search criteria selected from the group consisting of empty legs, other service requests, and reverse service.

47. The method of embodiment 44, further comprising:
assigning an initial match between the first travel service request and the second travel service request based on a comparison of the first travel information and the second travel information;

48. The method of embodiment 47, wherein the comparison of the first travel information and the second travel information further comprises:
determining a first distance between the first arrival location and the second departure location;
wherein the initial match is only assigned if the first distance is less than a first threshold distance.

49. The method of embodiment 47, wherein the comparison of the first travel information and the second travel information further comprises:
determining a time interval between a first arrival time associated with the first time of travel and a second departure time associated with the second time of travel;
wherein the initial match is only assigned if the time interval is less than a first time interval threshold.

50. The method of embodiment 35, wherein the first travel service request is configured as an e-mail message.

51. The method of embodiment 35, wherein the first travel service request is configured as entries to a structured form.

52. The method of embodiment 35, further comprising:
providing a travel service fulfillment match in response to the first travel service request, the first travel service fulfillment comprising at least a reservation of travel service equipment for the first travel service request and further comprising an unoccupied return transit; and
wherein determining the correlation between the first travel service request and the second travel service request comprises:
   correlating the second travel service request to information associated with the unoccupied return transit.

53. The method of embodiment 35, wherein, if the correlation does not meet correlation threshold criteria, periodically receiving additional travel service requests and determining new correlations between the first travel service request and the additional travel service requests until a new correlation meeting the correlation threshold criteria is found.

54. An apparatus embodiment to facilitate matching of travel service requests, comprising:
a processor;
a memory in communication with the processor having instructions stored therein, the instructions executable by the processor to:
   receive a first travel service request comprising first travel information including at least a first departure location, first arrival location, and first time of travel;
   receive a second travel service request comprising second travel information including at least a second departure location, second arrival location, and a second time of travel;
   determine a correlation between the first travel service request and the second travel service request based on the first travel information and the second travel information; and
   store a paired relationship between the first travel service request and the second travel service request in a database if the correlation meets correlation threshold criteria.

55. The apparatus of embodiment 54, further comprising:
provide a travel service fulfillment match in response to the first travel service request, the first travel service fulfillment comprising at least a reservation of travel service equipment for the first travel service request and further comprising an unoccupied return transit; and
wherein determine the correlation between the first travel service request and the second travel service request comprises:
   correlate the second travel service request to information associated with the unoccupied return transit.

56. A processor-accessible medium embodiment to facilitate matching of travel service requests, comprising:
processor readable instructions stored in the processor-accessible medium, wherein the processor readable instructions are issuable by the processor to:
   receive a first travel service request comprising first travel information including at least a first departure location, first arrival location, and first time of travel;
   receive a second travel service request comprising second travel information including at least a second departure location, second arrival location, and a second time of travel;
   determine a correlation between the first travel service request and the second travel service request based on the first travel information and the second travel information; and
   store a paired relationship between the first travel service request and the second travel service request in a database if the correlation meets correlation threshold criteria.

57. The medium of embodiment 56, further comprising:
provide a travel service fulfillment match in response to the first travel service request, the first travel service fulfillment comprising at least a reservation of travel service equipment for the first travel service request and further comprising an unoccupied return transit; and
wherein determine the correlation between the first travel service request and the second travel service request comprises:
   correlate the second travel service request to information associated with the unoccupied return transit.

1. A computer-implemented method for managing processed charter data comprising:
receiving a first charter data search request;
identifying a charter indicator within the first charter data search request;
processing the first charter data search request to derive charter location, time and equipment request information;
correlating the processed request information of the first charter data search request to available charter data from a flight data record as initial search results; and
displaying a best match result to the first charter data search request and alternates to the best match.

2. The method of claim 1, further comprising:
receiving a selection of one of the displayed search results; and
storing the selection as a pending one-leg service request.

3. The method of claim 2, further comprising:
receiving a second charter data search request;
identifying a charter indicator within the second charter data search request;
processing the second charter data search request to derive charter location, time and equipment request information;
determining if the processed request information of the second charter data search request is complementary to a pending one-leg service request;
if the processed request information of the second charter data search request is complementary to a pending one-leg service request, identifying the two charter data search requests as a best match dual one-leg charter facilitation pair and displaying the updated matching results;
if the processed request information of the second charter data search request is not complementary to a pending one-leg service request:
   correlating the processed request information to available charter data from a flight data record as initial search results;
   displaying a best match result to the second charter data search request and alternates to the best match;
   receiving a selection of one of the displayed search results; and
   storing the selection as a pending one-leg service request.

4. The method of claim 3, wherein the first and second charter data search requests are configured as visual-based charter data search requests.

5. The method of claim 3, wherein the first and second charter data search requests are configured as textual based charter data search request.

6. The method of claim 5, wherein the textual based charter data search request is a non-structured request document.

7. The method of claim 6, wherein the non-structured request document is configured as an email.

8. The method of claim 3, wherein the determination process includes identifying alternates to the best match dual one-leg charter facilitation pair based on available equipment.

9. The method of claim 3, wherein the determination process includes identifying alternates to the best match dual one-leg charter facilitation pair based on available destination or departure times.

10. The method of claim 3, wherein the determination process includes identifying alternates to the best match dual one-leg charter facilitation pair based on available destination or departure location.

11. The method of claim 3, wherein the determination process includes identifying alternates to the best match dual one-leg charter facilitation pair based on equipment that may be relocated to create improved match results.

12. The method of claim 3, wherein if the processed request information of the second charter data search request is not complementary to a pending one-leg service request, the correlation process includes identifying alternates for the identified best match based on available equipment.

13. The method of claim 3, wherein if the processed request information of the second charter data search request is not complementary to a pending one-leg service request, the correlation process includes identifying alternates for the identified best match based on available destination or departure times.

14. The method of claim 3, wherein if the processed request information of the second charter data search request is not complementary to a pending one-leg service request, the correlation process includes identifying alternates for the identified best match based on available destination or departure location.

15. The method of claim 3, wherein if the processed request information of the second charter data search request is not complementary to a pending one-leg service request, the correlation process includes identifying alternates for the identified best match based on equipment that may be relocated to create improved match results.

16. The method of claim 3, wherein identifying the two charter data search requests as a best match dual one-leg charter facilitation pair and displaying the updated matching results includes determining fare information for both matched charter data search requests.

17. The method of claim 16, wherein determining fare information includes determining fare discounts that depend on the number of days remaining until the departure date of the complementary pending one-leg service request.

18. A system for managing processed charter data comprising:
a memory in communication with the processor and containing program instructions;
an input and output in communication with the processor and memory;
wherein the processor executes program instructions contained in the memory and the program instructions comprise:
   receiving a first charter data search request;
   identifying a charter indicator within the first charter data search request;
   processing the first charter data search request to derive charter location, time and equipment request information;
   correlating the processed request information of the first charter data search request to available charter data from a flight data record as initial search results; and
   displaying a best match result to the first charter data search request and alternates to the best match.

19. The system of claim 18, wherein the processor also executes program instructions for:
receiving a selection of one of the displayed search results; and
storing the selection as a pending one-leg service request.

20. The system of claim 19, wherein the processor also executes program instructions for:
receiving a second charter data search request;
identifying a charter indicator within the second charter data search request;
processing the second charter data search request to derive charter location, time and equipment request information;
determining if the processed request information of the second charter data search request is complementary to a pending one-leg service request;
if the processed request information of the second charter data search request is complementary to a pending one-leg service request, identifying the two charter data search requests as a best match dual one-leg charter facilitation pair and displaying the updated matching results;
if the processed request information of the second charter data search request is not complementary to a pending one-leg service request:
   correlating the processed request information to available charter data from a flight data record as initial search results;
   displaying a best match result to the second charter data search request and alternates to the best match;
   receiving a selection of one of the displayed search results; and
   storing the selection as a pending one-leg service request.

21. The system of claim 19, wherein the first and second charter data search requests are configured as visual-based charter data search requests.

22. The system of claim 19, wherein the first and second charter data search requests are configured as textual based charter data search request.

23. The system of claim 22, wherein the textual based charter data search request is a non-structured request document.

24. The system of claim 23, wherein the non-structured request document is configured as an email.

25. The system of claim 20, wherein the determination process includes identifying alternates to the best match dual one-leg charter facilitation pair based on available equipment.

26. The system of claim 20, wherein the determination process includes identifying alternates to the best match dual one-leg charter facilitation pair based on available destination or departure times.

27. The system of claim 20, wherein the determination process includes identifying alternates to the best match dual one-leg charter facilitation pair based on available destination or departure location.

28. The system of claim 20, wherein the determination process includes identifying alternates to the best match dual one-leg charter facilitation pair based on equipment that may be relocated to create improved match results.

29. The system of claim 20, wherein if the processed request information of the second charter data search request is not complementary to a pending one-leg service request, the correlation process includes identifying alternates for the identified best match based on available equipment.

30. The system of claim 20, wherein if the processed request information of the second charter data search request is not complementary to a pending one-leg service request, the correlation process includes identifying alternates for the identified best match based on available destination or departure times.

31. The system of claim 20, wherein if the processed request information of the second charter data search request is not complementary to a pending one-leg service request, the correlation process includes identifying alternates for the identified best match based on available destination or departure location.

32. The system of claim 20, wherein if the processed request information of the second charter data search request is not complementary to a pending one-leg service request, the correlation process includes identifying alternates for the identified best match based on equipment that may be relocated to create improved match results.

33. The system of claim 20, wherein identifying the two charter data search requests as a best match dual one-leg charter facilitation pair and displaying the updated matching results includes determining fare information for both matched charter data search requests.

34. The method of claim 33, wherein determining fare information includes determining fare discounts that depend on the number of days remaining until the departure date of the complementary pending one-leg service request.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program modules (a module collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A processor-implemented method to facilitate matching of travel service requests, comprising:
receiving a first travel service request comprising first travel information including at least a first departure location, first arrival location, and first time of travel;
receiving a second travel service request comprising second travel information including at least a second departure location, second arrival location, and a second time of travel;
determining a correlation between the first travel service request and the second travel service request based on the first travel information and the second travel information; and
storing a paired relationship between the first travel service request and the second travel service request in a database if the correlation meets correlation threshold criteria.

2. The method of claim 1, wherein determining a correlation further comprises:
comparing the first arrival location and the second departure location to derive a first location comparison; and
determining the correlation between the first travel service request and the second travel service request based on the first location comparison, the first time of travel, and the second time of travel.

3. The method of claim 2, wherein the correlation meets the correlation threshold criteria only if the first location comparison indicates that a distance between the first arrival location and the second departure location is less than a first threshold distance.

4. The method of claim 3, wherein determining a correlation further comprises:
comparing the first departure location and the second arrival location to derive a second location comparison; and
determining the correlation between the first travel service request and the second travel service request further based on the second location comparison, wherein the correlation meets the correlation threshold criteria only if the second location comparison indicates that a distance between the first departure location and the second arrival location is less than a second threshold distance.

5. The method of claim 1, wherein the first time of travel includes at least a first arrival date and the second time of travel includes at least a second departure date, and wherein determining a correlation further comprises:
comparing the first arrival date and second departure date to derive a first time comparison; and
wherein the correlation meets the correlation threshold criteria only if the first time comparison is less than a first threshold time.

6. The method of claim 1, wherein determining a correlation further comprises:
retrieving the first travel information from a database based on analysis of the second travel information;
providing the first travel information for display to a second travel service request user submitting the second travel service request;
receiving a selection associated with the first travel information from the second travel service request user;
wherein the correlation meets correlation threshold criteria only if the selection associated with the first travel information is received.

7. The method of claim 6, wherein retrieving the first travel information from a database based on analysis of the second travel information further comprises:
comparing the first arrival location to the second departure location to derive a first location comparison;
comparing the first time of travel to the second time of travel to derive a first time comparison; and
wherein the first travel information is only retrieved if the first location comparison is less than a first distance threshold and the first time comparison is less than a first time threshold.

8. The method of claim 7, wherein the first location comparison comprises a distance between the first arrival location and the second departure location.

9. The method of claim 7, wherein the first time comparison comprises a difference between a first arrival time associated with the first time of travel and a second departure time associated with the second time of travel.

10. The method of claim 1, wherein determining a correlation further comprises:
providing the first and second travel service requests for display to a system administrator;
receiving a pair selection of the first and second travel service requests from the system administrator;
wherein the correlation meets the correlation threshold criteria only if the pair selection of the initially matched first and second travel service requests is received.

11. The method of claim 10, wherein providing, the initially matched first and second travel service requests occur in response to a search request.

12. The method of claim 11, wherein the search request comprises at least a departure location, an arrival location, a travel date, and search criteria selected from the group consisting of empty legs, other service requests, and reverse service.

13. The method of claim 10, further comprising:
assigning an initial match between the first travel service request and the second travel service request based on a comparison of the first travel information and the second travel information;

14. The method of claim 13, wherein the comparison of the first travel information and the second travel information further comprises:
determining a first distance between the first arrival location and the second departure location;
wherein the initial match is only assigned if the first distance is less than a first threshold distance.

15. The method of claim 13, wherein the comparison of the first travel information and the second travel information further comprises:
determining a time interval between a first arrival time associated with the first time of travel and a second departure time associated with the second time of travel;
wherein the initial match is only assigned if the time interval is less than a first time interval threshold.

16. The method of claim 1, wherein the first travel service request is configured as an e-mail message.

17. The method of claim 1, wherein the first travel service request is configured as entries to a structured form.

18. The method of claim 1, further comprising:
providing a travel service fulfillment match in response to the first travel service request, the first travel service fulfillment comprising at least a reservation of travel service equipment for the first travel service request and further comprising an unoccupied return transit; and
wherein determining the correlation between the first travel service request and the second travel service request comprises:
correlating the second travel service request to information associated with the unoccupied return transit.

19. The method of claim 1, wherein, if the correlation does not meet correlation threshold criteria, periodically receiving additional travel service requests and determining new correlations between the first travel service request and the additional travel service requests until a new correlation meeting the correlation threshold criteria is found.

20. An apparatus to facilitate matching of travel service requests, comprising:
a processor;
a memory in communication with the processor having instructions stored therein, the instructions executable by the processor to:
receive a first travel service request comprising first travel information including at least a first departure location, first arrival location, and first time of travel;
receive a second travel service request comprising second travel information including at least a second departure location, second arrival location, and a second time of travel;
determine a correlation between the first travel service request and the second travel service request based on the first travel information and the second travel information; and
store a paired relationship between the first travel service request and the second travel service request in a database if the correlation meets correlation threshold criteria.

21. The apparatus of claim 20, further comprising:
provide a travel service fulfillment match in response to the first travel service request, the first travel service fulfillment comprising at least a reservation of travel service equipment for the first travel service request and further comprising an unoccupied return transit; and
wherein determine the correlation between the first travel service request and the second travel service request comprises:
correlate the second travel service request to information associated with the unoccupied return transit.

22. A processor-accessible medium to facilitate matching of travel service requests, comprising:
processor readable instructions stored in the processor-accessible medium, wherein the processor readable instructions are issuable by the processor to:
receive a first travel service request comprising first travel information including at least a first departure location, first arrival location, and first time of travel;
receive a second travel service request comprising second travel information including at least a second departure location, second arrival location, and a second time of travel;
determine a correlation between the first travel service request and the second travel service request based on the first travel information and the second travel information; and
store a paired relationship between the first travel service request and the second travel service request in a database if the correlation meets correlation threshold criteria.

23. The medium of claim 1, further comprising:
provide a travel service fulfillment match in response to the first travel service request, the first travel service fulfillment comprising at least a reservation of travel service equipment for the first travel service request and further comprising an unoccupied return transit; and
wherein determine the correlation between the first travel service request and the second travel service request comprises:
correlate the second travel service request to information associated with the unoccupied return transit.
